(19) United States
(12) Patent Application Publication
(10) Pub. No.: US 2008/0052379 A1
(43) Pub. Date: Feb. 28, 2008

(54) NETWORK ANALYSIS ASSISTING APPARATUS AND METHOD, PROGRAM AND RECORDING MEDIUM

(76) Inventors: Shinako MATSUYAMA, Tokyo (JP); Yu Hamada, Tokyo (JP); Tetsuya Shiraishi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/842,671

(22) Filed: Aug. 21, 2007

(30) Foreign Application Priority Data
Aug. 25, 2006 (JP) 2006-228598

(51) Int. Cl. G06F 15/16

(52) U.S. Cl. 709/218

(57) ABSTRACT

A network analysis assisting apparatus for assisting analysis of a network formed from a plurality of nodes and edges indicating interconnection between the nodes includes a modifying control unit that receives a designation of a node attribute indicating a meaning of a node to be added to the network or a designation of an edge attribute indicating a meaning of an edge to be added to the network, and determining an addition location of the node or edge to be added in the network, based on the node attribute or the edge attribute designated by the designation, and a structure of the network.

### BACKGROUND OF THE INVENTION

1. Field of the Invention

The present invention relates to a network analysis assisting apparatus and method, a program and a recording medium, and more particularly to a network analysis assisting apparatus and method, which allows a user to analyze a network easily, and a program and a recording medium.

2. Description of Related Art

There is a related art approach to analyzing the tendencies and features of a set of elements by analyzing the set as a network using each element as a node and edges interconnecting related elements. In order to assist this analysis, there has also been an approach to visualization (graph representation) of a target network for analysis.

For example, in genome researches or the like, the relevancy, particularly commonness, of particular genes among a number of target data items has been paid attention, and a method has been proposed by which first and second networks are displayed in order for an analyzer to intuitively grasp the features of the particular genes, in the first network, two element nodes having a common attribute being connected by an edge, and in the second network, an element node and an attribute node having an attribute possessed by the element node being connected by an edge (e.g., refer to Japanese Patent Application Publication No. 2004-265179), Further, for example, there is another method of creating a relevancy graph by representing a relevancy among objects in graph format based on an attribute of each object and two objects having an edge intensity not smaller than a predetermined amount are coupled by an edge, in order to visually and easily confirm the relevancy among arbitrary objects (e.g., refer to Japanese Patent Application Publication No. 2006-39990).

### SUMMARY OF THE INVENTION

More complicated networks are analyzed in recent years, and a variety of analyzing methods are required for this purpose. However, related art methods cannot deal with a dynamic change in nodes and edges and have a disadvantage that, for example, it is difficult to perform analysis or the like of the influence of the dynamic change upon a whole network.

For example, both the methods described in Japanese Patent Application Publications Nos. 2004-265179 and 2006-39990 cannot perform addition, deletion, change or the like of nodes and edges of a network. It is therefore unable to assist analysis of the influence of dynamic change upon the network.

Accordingly, it is desirable that nodes and edges of a network can be changed dynamically so as to allow a user to perform a variety of analyses of the network. The present invention is made in view of the above-described circumstance.

According to one embodiment of the present invention, there is provided a network analysis assisting apparatus for assisting analysis of a network formed from a plurality of nodes and edges indicating interconnection between the nodes, including: modifying control means for receiving a designation of a node attribute indicating a meaning of a node to be added to the network or a designation of an edge attribute indicating a meaning of an edge to be added to the network, and determining an addition location of the node or edge to be added in the network, based on the node attribute or the edge attribute designated by the designation, and a structure of the network.

The modifying control means may further receive a designation of the number of nodes or edges to be added, and determines addition locations of nodes or edges in the network. The same number of the addition locations as the number of nodes or edges designated by the designation are determined.

The network analysis assisting apparatus may further include modifying means for adding the nodes or edges to the addition locations of the network determined by the modifying control means.

The modifying control means may further receive a designation of a node attribute indicating a meaning of a node to be deleted from the network or a designation of an edge attribute indicating a meaning of an edge to be deleted from the network, and select a node or edge to be deleted, based on the node attribute or the edge attribute designated by the designation, and the stricture of the network.

The network analysis assisting apparatus may further include modifying means for deleting the node or the edge selected by the modifying control means.

According to another embodiment of the present invention, there is provided a network analysis assisting method for a network analysis assisting apparatus that assists analysis of a network formed from a plurality of nodes and edges indicating interconnection between the nodes, a program or a recording medium recording the program, including: a modifying control step of receiving a designation of a node attribute indicating a meaning of a node to be added to the network or a designation of an edge attribute indicating a meaning of an edge to be added to the network, and determining an addition location of the node or edge to be added in the network, based on the node attribute or the edge attribute designated by the designation, and a structure of the network.

According to the embodiments of the present invention, a designation of a node attribute indicating a meaning of a node to be added to the network or a designation of an edge attribute indicating a meaning of an edge to be added to the network, is received and an addition location of the node or edge to be added in the network, is determined based on the node attribute or the edge attribute designated by the designation and a stricture of the network.

According to the embodiments of the present invention, it is possible to analyze a network. Nodes and edges can be changed dynamically, particularly so as to allow a user to easily perform various analyses of the network.

### BRIEF DESCRIPTION OF THE DRAWINGS

FIG. 1 is a block diagram showing an example of the structure of a network analysis assisting apparatus adopting the present invention;

FIG. 2 is a diagram showing an example of graph display;

FIG. 3 is a diagram showing an example of the structure of graph data;

FIG. 4 is a diagram showing an example of the structure of functional blocks;

FIG. 5 is a flow chart illustrating an example of the sequence of a main menu process;

FIG. 6 is a flow chart illustrating an example of the sequence of a graph creating process;

FIG. 7 is a flow chart illustrating an example of the sequence of a graph routine updating process;

FIG. 8 is a flow chart illustrating an example of the sequence of an attribute setting process;

FIG. 9 is a flow chart illustrating an example of the sequence of the attribute setting process following the flow chart of FIG. 8;

FIG. 10 is a flow chart illustrating an example of the sequence of a graph modifying process;

FIG. 11 is a flow chart illustrating an example of the sequence of the graph modifying process following the flow chart of FIG. 10;

FIG. 12 is a flow chart illustrating an example of the sequence of the graph modifying process following the flow chart of FIG. 11;

FIG. 13 is a flow chart illustrating an example of the sequence of the graph modifying process following the flow chart of FIG. 12;

FIG. 14 is a diagram showing a display example of a node adding window;

FIG. 15 is a diagram showing an example of node addition results;

FIG. 16 is a diagram showing another display example of the node adding window;

FIG. 17 is a diagram showing another example of node addition results;

FIG. 18 is a diagram showing a display example of an edge adding window;

FIG. 19 is a diagram showing an example of edge addition results;

FIG. 20 is a diagram showing another display example of the edge adding window;

FIG. 21 is a diagram showing another example of edge addition results;

FIG. 22 is a diagram showing a display example of a node deleting window;

FIG. 23 is a diagram showing an example of node deletion results;

FIG. 24 is a diagram showing another display example of the node deleting window;

FIG. 25 is a diagram showing another example of node deletion results;

FIG. 26 is a diagram showing a display example of an edge deleting window;

FIG. 27 is a diagram showing an example of edge deletion results;

FIG. 28 is a diagram showing another display example of the edge deleting window;

FIG. 29 is a diagram showing another example of edge deletion results;

FIG. 30 is a diagram showing still another example of graph display;

FIG. 31 is a flow chart illustrating an example of the sequence of a holding process;

FIG. 32 is a flow chart illustrating an example of the sequence of a terminating process;

FIG. 33 is a block diagram showing an example of a configuration of a network analysis assisting apparatus system adopting the present invention; and

FIG. 34 is a block diagram showing an example of the structure of a personal computer adopting the present invention.

### DETAILED DESCRIPTION OF EMBODIMENT

In the following description of the embodiments of the present invention, the correspondence between the disclosed inventions and the embodiments is as follows. The description is used for confirming that the embodiments supporting the inventions described in this specification are described in the specification. Therefore, the embodiment described in this specification as not corresponding to some invention is not intended to mean that the embodiment does not correspond to the invention. Conversely, the embodiment described in this specification as corresponding to some invention is not intended to mean that the embodiment does not correspond to the invention other than some invention.

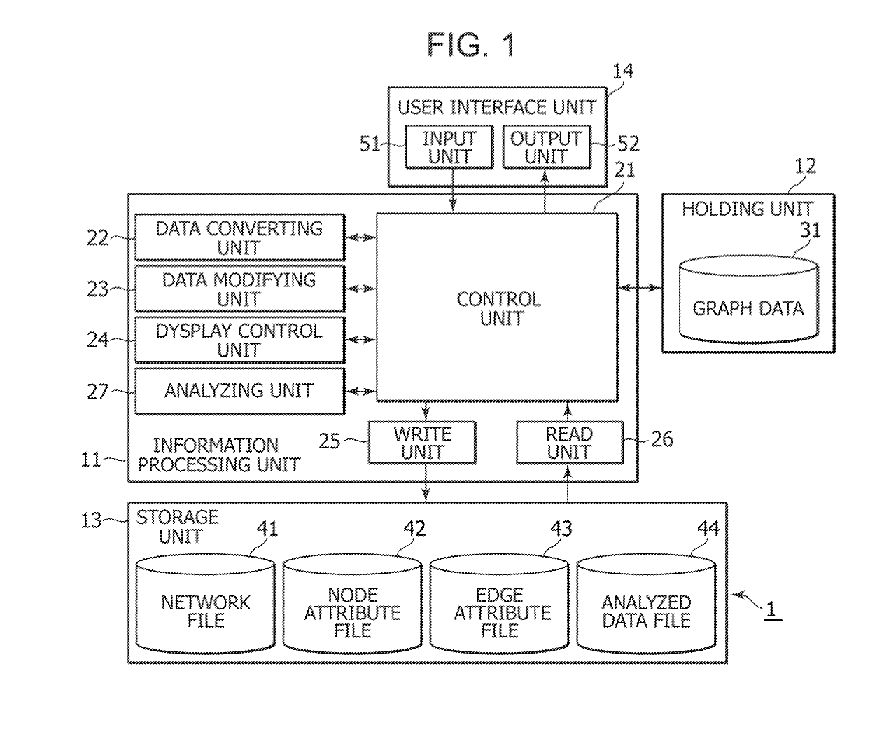

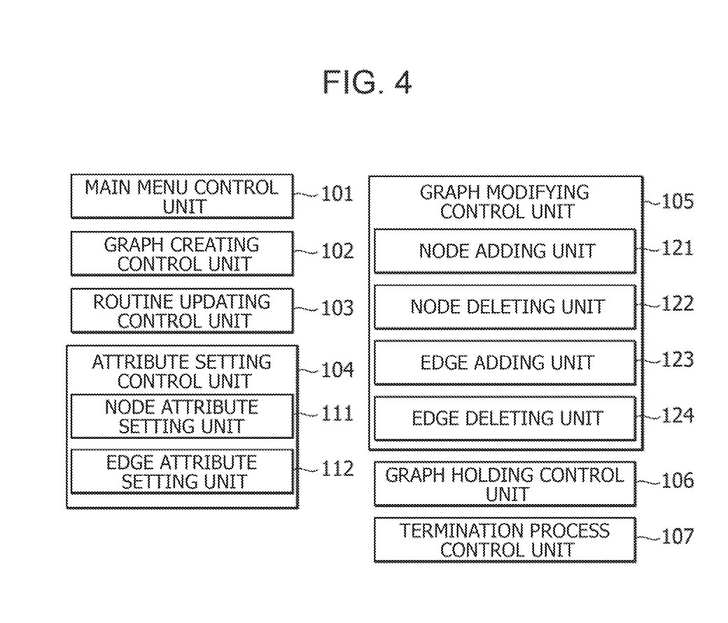

According to one embodiment of the present invention, a network analysis assisting apparatus (e.g., a network analysis assisting apparatus 1 shown in FIG. 1) for assisting analysis of a network formed from a plurality of nodes and edges indicating interconnection between the nodes, includes: modifying control means (e.g., a graph modifying control unit 105 shown in FIG. 4) for receiving a designation of a node attribute indicating a meaning of a node to be added to the network or a designation of an edge attribute indicating a meaning of an edge to be added to the network, and determining an addition location of the node or edge to be added in the network, based on the node attribute or the edge attribute designated by the designation, and a structure of the network.

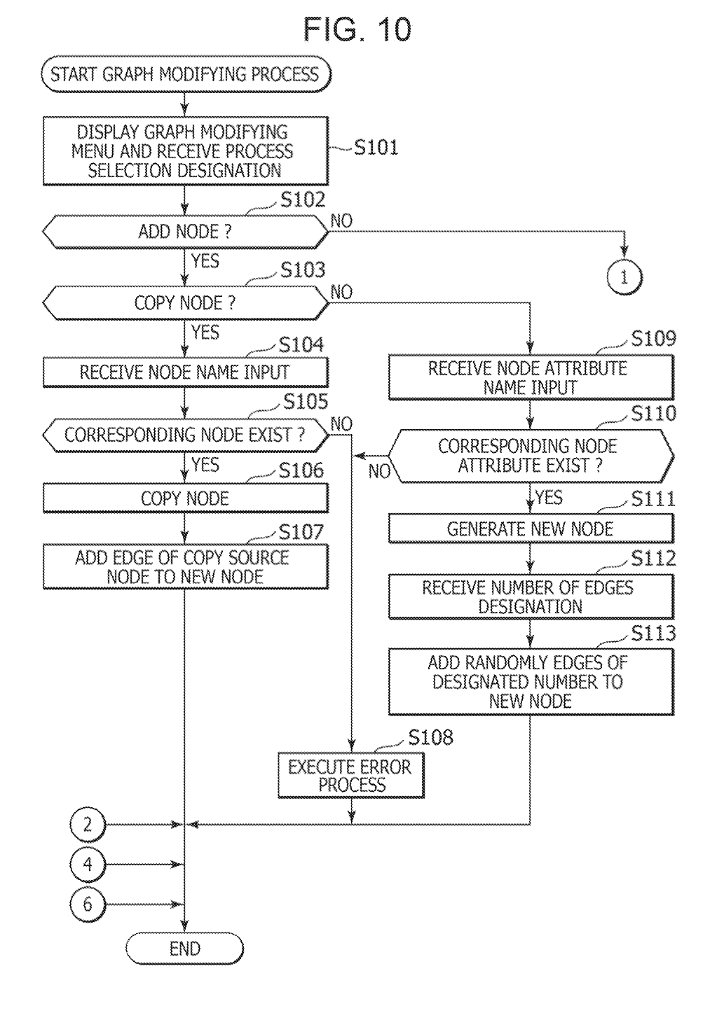

The modifying control means may further receive a designation of the number of nodes or edges to be added (e.g., Step S112 shown in FIG. 10), and determine addition locations of nodes or edges in the network. The same number of the addition locations as the number of nodes or edges designated by the designation are determined.

The network analysis assisting apparatus may further include modifying means (e.g., a graph modifying unit 23 shown in FIG. 1) for adding the nodes or edges to the addition locations of the network determined by the modifying control means.

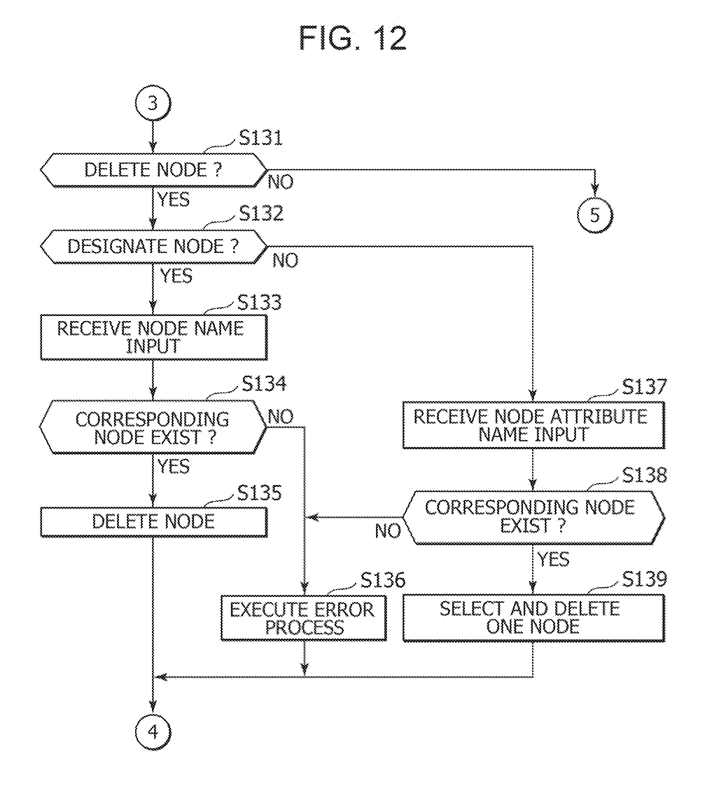

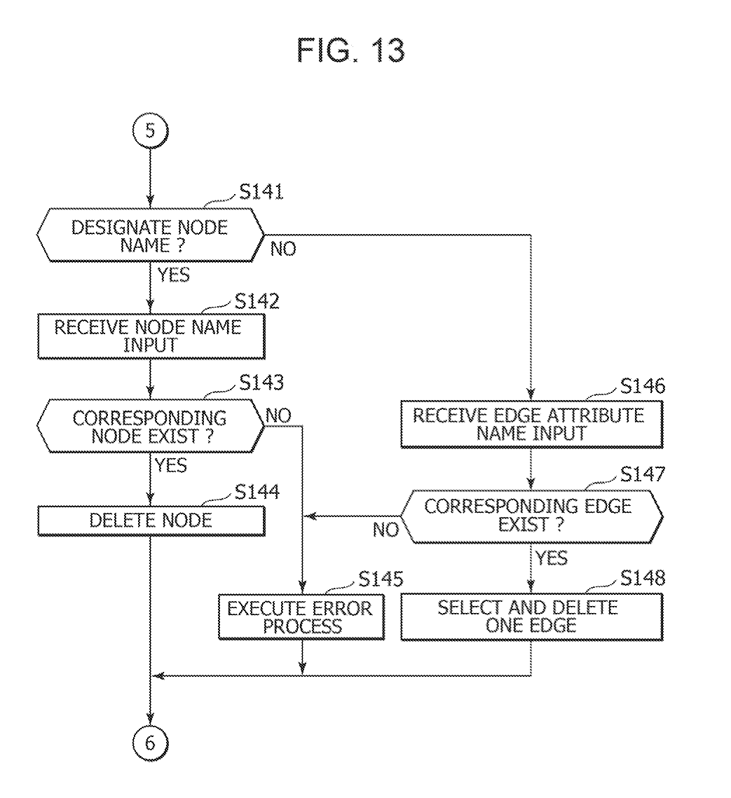

The modifying control means may further receive a designation of a node attribute indicating a meaning of a node to be deleted from the network or a designation of an edge attribute indicating a meaning of an edge to be deleted from the network, and select a node or edge to be deleted, based on the node attribute or the edge attribute designated by the designation, and the structure of the network (e.g., Step S139 shown in FIG. 12 and Step S148 shown in FIG. 13).

The network analysis assisting apparatus may further include modifying means (e.g., a graph modifying unit 23 shown in FIG. 1) for deleting the node or the edge selected by the modifying control means.

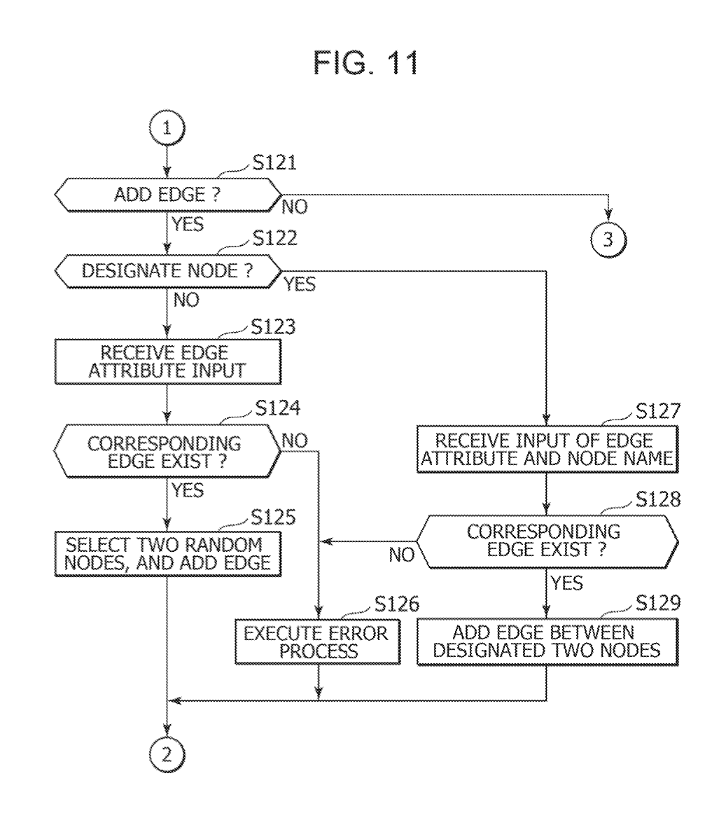

According to another embodiment of the present invention, a network analysis assisting method for a network analysis assisting apparatus (e.g., a network analysis assisting apparatus 1 shown in FIG. 1) that assists analysis of a network formed from a plurality of nodes and edges indicating interconnection between the nodes, includes: a modifying control step (e.g., Step S113 shown in FIG. 10 and Step S125 shown in FIG. 11) of receiving a designation of a node attribute indicating a meaning of a node to be added to the network or a designation of an edge attribute indicating a meaning of an edge to be added to the network, and determining an addition location of the node or edge to be added in the network, based on the node attribute or the edge attribute designated by the designation and a structure of the network, and there are provided a program and a recording medium recording the program.

Embodiments of the present invention will now be described.

FIG. 1 is a block diagram showing an example of the structure of a network analysis assisting apparatus system adopting the present invention.

Referring to FIG. 1, the network analysis assisting apparatus 1 is an information processing apparatus for assisting a network analysis work by visualizing (performing graph representation on) a set of elements as a network using each element as a node and edges representative of the relation (interconnection) among elements, in order for an analyzing user to intuitively (visually) grasp the features and tendencies of the set.

As shown in FIG. 1, the network analysis assisting apparatus 1 includes: as its main constituents, an information processing unit 11 which is a processing unit for executing various processes such as a data converting process, an analyzing process and a display control process; a holding unit 12 for holding generated graph data 31; a storage unit 13 for storing information on nodes and edges as files; a user interface unit 14 constituted of input-output devices for users and the like such as a monitor and a keyboard.

The information processing unit 11 includes: a control unit 21; a data converting unit 22, a graph modifying unit 23, a display control unit 24, a write unit 25, a read unit 26 and an analyzing unit 27. The control unit 21 controls each constituent and executes a network analysis assisting apparatus process, as will be later described. Functional blocks in the control unit 21 will be later described.

The data converting unit 22 is a unit for executing a data conversion related process under control of the control unit 21, and generates graph data 31, for example, by representing nodes and edges described in record data (file) in graph format and defining the attributes of nodes and edges in a graph. Conversely, the data converting unit 22 converts (files) a graphed network into record data under control of the control unit 21.

Under control of the control unit 21, the graph modifying unit 23 performs addition, deletion, change or the like of nodes and edges relative to the graph displayed on a monitor, and returns the results to the control unit 21. The display control unit 24 executes a display process of a graphed network and the like. The write unit 25 writes data (file) into the storage unit 13, and the read unit 26 reads data (file) stored in the storage unit 13.

The analyzing unit 27 analyzes a network graphed by the graph data 31 by an analyzing method designated by the control unit 21, and returns the analyzed results to the control unit 21.

The holding unit 12 includes a volatile memory such as a random access memory (RAM), and temporarily holds results and intermediate progresses by the control unit 21. For example, as shown in FIG. 1, the holding unit 12 holds the graph data 31 generated by representing a network in graph format under control of the control unit 21.

The storage unit 13 includes a large capacity nonvolatile storage medium such as a hard disk and a flash memory, and stores various data filed for storage. For example, as shown in FIG. 1, the storage unit 13 holds: a network file 41 including information on nodes, edges and relations thereof; a node attribute file 42 including information on node attributes representative of features of each node; an edge attribute file 43 including information on edge attributes representative of features or each edge; an analyzed data file 44 including analyzed data of a network; and the like.

The network file 41 stores text data describing a list of nodes and edges of a network. For example, if a node is a user, names such as user 1, user 2, user 3, . . . are assigned to nodes as node names, and the network file 41 includes a list of such node names. The network file 41 further includes a list of information on edges indicating which node is coupled to which node by an edge.

The node attribute file 42 stores text data describing a list of node attributes of nodes in a network. A node attribute is information on the features and the like of each node. For example, if a node is a user, the node attribute may be gender, age, occupation, address, hobby and the like of the user. Namely, the node attribute is information on the meaning of one element in a network. The edge attribute file 43 stores text data describing a list of edge attributes of edges in a network. An edge attribute is information on the features and the like of each edge. For example, if a node is a user and an edge is a human relation, the edge attribute may be items indicating the features of human relation such as same hobby, class mate, gender, and speech. Namely, the edge attribute is information on the meaning of interconnection between elements in a network.

The analyzed data file 44 stores text data of analyzed results of a network.

These Files include, for example, text files or comma separated values (CSV) files. Data other than text data may obviously be stored.

The user interface unit 14 has an input unit 51 such as a keyboard and a mouse and an output unit 52 such as a monitor and a speaker, and executes a process for an user interface by executing a process for image display and user designation input reception under control of the control unit 21.

Under control of the control unit 21, the network analysis assisting apparatus 1 makes the input unit 51 receive a user designation, makes the read unit 26 read the network file 41 stored in the storage unit 13, makes the data converting unit 22 perform the graph representation of a list of nodes and edges stored in the network file 41, makes the holding unit 12 hold generated graph data 31, and makes the display control unit 24 display graph images on a monitor of the output unit 52. If there exist the node attribute file 42, edge attribute file 43, analyzed data file 44 and the like, the data converting unit 22 reflects various data stored in these files upon the graphed network.

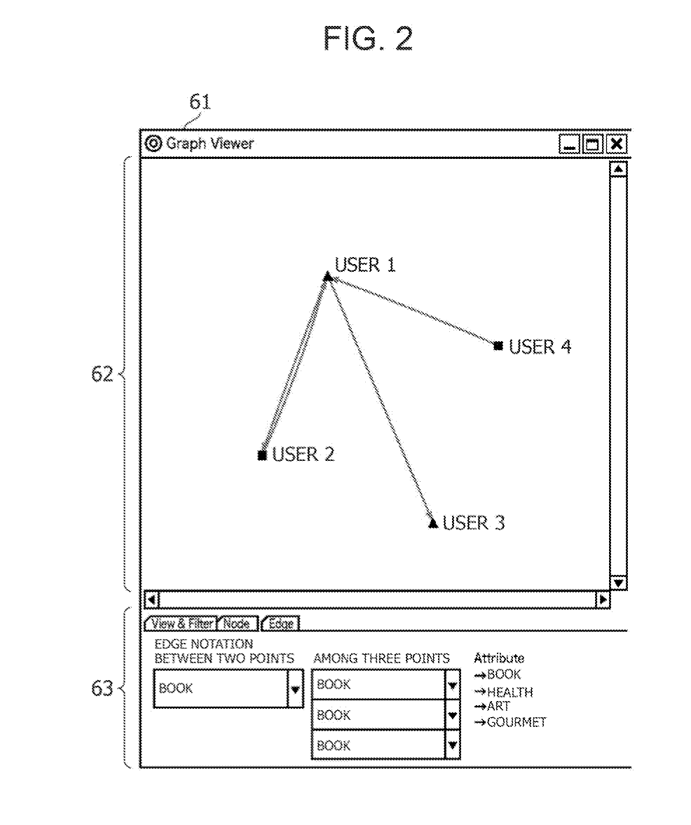

In this manner, the network analysis assisting apparatus 1 images a network described in the network file 41 and the like as a graph and displays the graph on the monitor. FIG. 2 shows an example of graph display on the monitor of the output unit. As shown in FIG. 2, when a graph is displayed, a graph viewer 61 as a graphical user interface (GUI) is displayed on the monitor screen as a window. The graph viewer 61 includes a display area 62 and an operation area 63, and a graph is displayed in the display area 62. A user operates a GUI button or the like disposed in the operation area 63 so that the graph displayed in the display area 62 can be analyzed and edited.

Next, a graph displayed in the display area 62 in FIG. 2 will be described. In FIG. 2, points (triangles and squares) drawn as user 1 to user 4 represent nodes, and arrow symbols interconnecting nodes represent edge. The network includes nodes representative of elements, and edges representative of the relations among the nodes. The graph representation is performed in such a manner that the node attribute is represented by visual features such as shape, color, pattern, density and size of the point representative of the node, and that the edge attribute is represented by visual features such as color, pattern, solid line, dotted line, chain line, density and size of the arrow symbol representative of the edge. A direction of an arrow symbol indicates a direction of the relation between nodes at opposite ends of an edge (e.g., a direction of reference relation and a direction of dependency relation).

For example, the network shown in FIG. 2 indicates a usage state of speech services such as telephone, and the network is graphed in such a manner that the node indicates a member (user) of the speech services, the edge indicates usage of the speech services between users, the shape of the node indicates gender of the user, a direction of the arrow symbol of the edges indicates a teller and a receiver, and a visual difference of the arrow symbol indicates a speech frequency and main speech contents (e.g., statistical information acquired by questionnaire results).

The graph representation (visualization) of a network in this manner allows an analyzer to visually grasp the features and tendencies of the network, such as “user 1 not only has the highest service usage frequency but also is the common speech partner of user 2 to user 4, and serves as a large factor of making user 2 to user 4 use services”, and provides easy analysis. The network analysis assisting apparatus 1 not only simply visualizes the network but also has an editing function and the like to be later described. Therefore, the analyzer can further deepen the analysis and perform sophisticated analyses including simulation of how the whole network is influenced by addition and deletion of which nodes and edges, what usage of which user is promoted by providing a new service, and the like. Namely, the network analysis assisting apparatus 1 can assist such sophisticated analyses.

A graphed network may display any type of data so long as the network includes nodes representative of elements and edges representative of the relation among nodes. For example, the network may display not only the usage state of various services but also protein structures, statistical information, network of electronic apparatus such as LAN, and the like. Namely, nodes and edges may represent any items. Further, arbitrary items may be assigned to the attributes of nodes and edges.

In FIG. 2, the network is graphed to a directed graph using an arrow symbol as the edge, i.e., the graph indicating also a direction of the relation between nodes. The network may be graphed to a non-directed graph using a line segment as the edge, i.e., the graph not considering the direction of the relation between nodes.

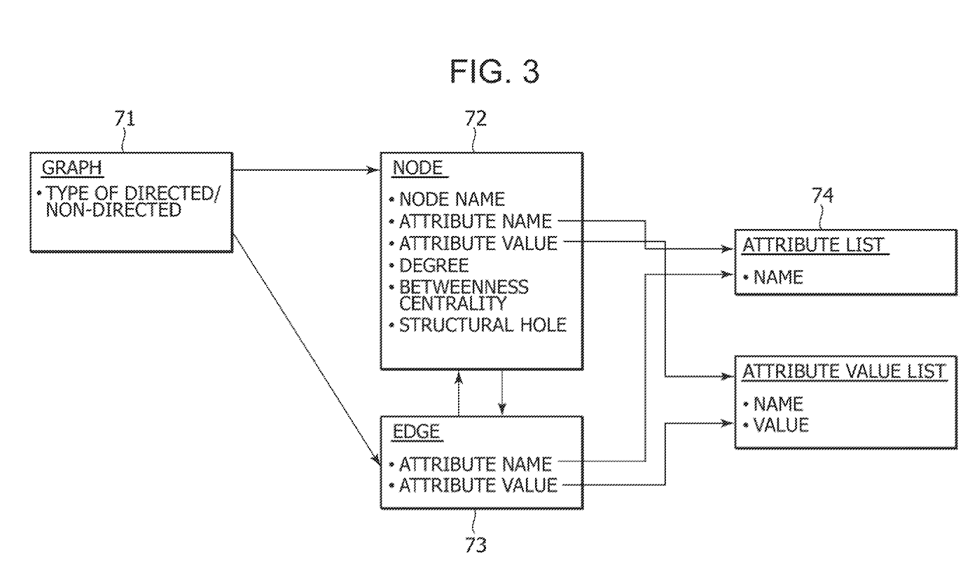

The graph data 31 (FIG. 1) representing a network in graph format in this manner has a structure such as shown in FIG. 3. In the example shown in FIG. 3, the graph data 31 has a graph 71 including information on the whole graph, a node 72 including information on each node, an edge 73 including information on each edge, an attribute list 74 including information on node and edge attributes, and an attribute value list 75.

The graph 71 includes a directed type or a non-directed type which is information on whether a network is displayed by a directed graph or a non-directed graph. The node 72 includes information on each node in a graph indicated by the graph 71, the node information including: a node name representative of the name of the node; an attribute name representative of the name of a node attribute; an attribute value representative of a value of a node attribute; a degree representative of the number of connected edges; a betweenness centrality representative of an influence degree upon another node; a structural hole representative of relation disconnection (a duplication degree of the relation between nodes indicated by an edge and the relation between nodes indicated by another edge); and the like. The edge 73 includes information on each edge in a graph represented by the graph type 71, the information including: an attribute name representative of the name of an edge attribute; an attribute value representative of the value of an edge attribute; and the like. The attribute list 74 is a list of the name of the node attribute of each node indicated in the node 72 and the name of the edge attribute of each edge indicated in the edge 73. The attribute value list 75 is a list of the name and attribute value of each node attribute indicated in the node 72 and the name and attribute value of each edge attribute indicated in the edge 73.

Based on the network file 41 and the like stored in the storage unit 13, the network analysis assisting apparatus 1 generates the graph data 31 including the various data described above, and displays the network as a graph on the monitor.

Next, description will be made on a specific process to be executed by the network analysis assisting apparatus 1. FIG. 4 is a diagram showing an example of the structure of functional blocks in the control unit 1 shown in FIG. 1.

As shown in FIG. 4, the control unit 21 includes: a main menu control unit 101 for executing a process regarding a main menu screen for receiving a selection designation of an execution process by a user; a graph creating control unit 102 for executing a process of representing a network in graph format; a routine updating control unit 103 for routinely updating a graph; an attribute setting control unit 104 for executing a process regarding settings of nodes and edges; a graph modifying control unit 105 for controlling the graph modifying unit 23 to execute a process regarding graph modifying; a graph holding control unit 106 for executing a process regarding graph holding; and a termination processing control unit 107 for controlling a termination process.

The attribute setting control unit 104 has a node attribute setting unit 111 for executing a process regarding settings of node attributes, and an edge attribute setting unit 112 for executing a process regarding settings of edge attributes. The graph display control unit 105 has: a node adding unit 121 for adding a node designated by a node name or a node attribute name to the graph, by controlling the graph modifying unit 23; a node deleting unit 122 for deleting a node designated by a node name or a node attribute name from the graph, by controlling the graph modifying unit 23; an edge adding unit 123 for adding an edge designated by an edge attribute name or a node name to the graph, by controlling the graph modifying unit 23; and an edge deleting unit 124 for deleting an edge designated by an edge attribute name or a node name from the graph, by controlling the graph modifying unit 23.

In the following, description will be made specifically on each process by referring to flow charts.

First, a main menu process will be described. For example, when a power source of the network analysis assisting apparatus 1 is turned on or when a user designation for starting up the main menu is received, the main menu control unit 101 controls the output unit 52 to display a main menu of the monitor to receive a selection designation from a user. The main menu is a GUI for making a user perform a main selection of a process to be executed by the network analysis assisting apparatus 1.

For example, the main menu is constructed in such a manner that a user can select any one of a process of creating a graph from a network and displaying the graph, a process of routinely updating the displayed graph, a process of setting attributes, a process regarding modifying a displayed graph, a process regarding graph storing and a terminating process. Namely, rough selection and important process selection are performed in the main menu. If a finer selection from selected processes is required, another menu is used.

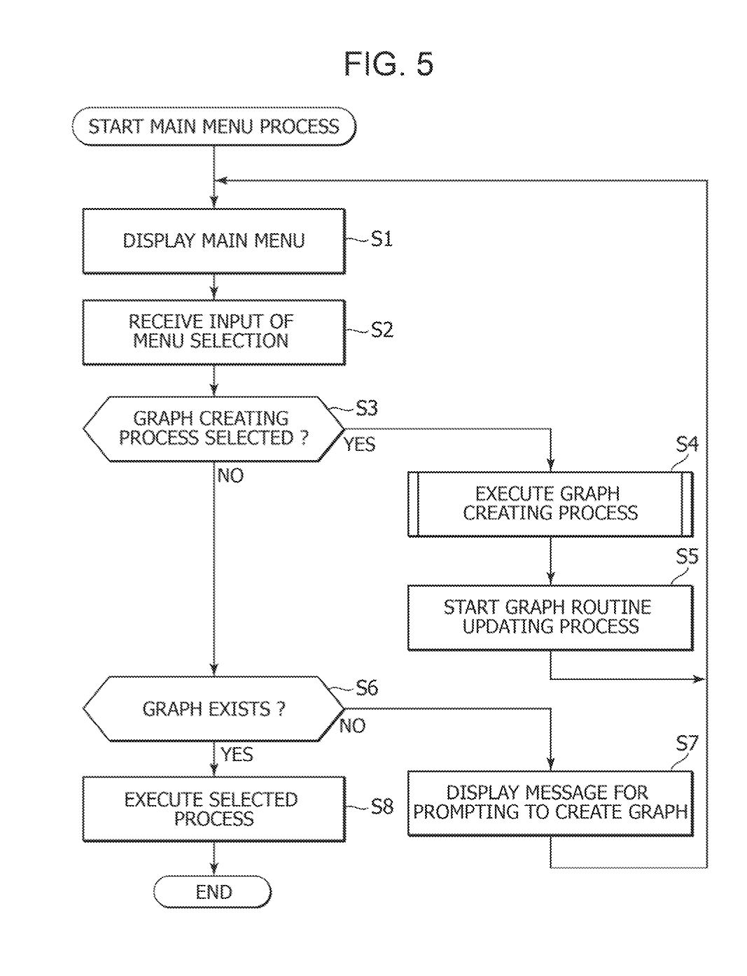

With reference to the flow chart of FIG. 5, description will be made on the main menu process to be executed by the main menu control unit 101 to execute a process regarding the main menu.

At Step S1 the main menu control unit 101 started the main menu process makes the output unit 52 display the main menu on the monitor. At Step S2 the input unit 51 is controlled to receive a main menu selection input. The main menu displays, for example, the list of process names of processes such as described previously, and a user operates the input unit 51 to move a cursor or the like and select one of the process names. With this operation, a main menu selection is input.

Upon reception of the menu selection input selecting one of the process names from the main menu, first at Step S3 the main menu control unit 101 judges whether the main menu selection input indicates a selection of a graph creating process. The graph creating process is a process of reading the network file 41 and the like from the storage unit 13, representing the network in graph format and displaying the graph. In the initial state (e.g. turn-on of the power source) when the main menu is activated, the network file 41 and the like are still not read, and a graph is not still displayed on the monitor (because the graph data 31 is not generated). Therefore, if another process (e.g., an analyzing process and a display control process) is to be executed, the graph creating process is required to be executed at least once.

If it is judged that the graph creating process is selected, the main menu control unit 101 advances the process to Step S4. At Step S4 the graph creating control unit 102 executes the graph creating process to perform graph representation of the network and display the graph on the monitor of the output unit 52, as shown in FIG. 2. After completion of the process at Step S4, at Step S5 the routine updating control unit 103 starts a graph routine updating process to routinely update the graph displayed on the monitor. As the routine updating control unit 103 starts the graph routine updating process, the main menu control unit 101 returns the process to Step S1 to repeat the succeeding processes.

If it is judged at Step S3 that the menu selection input indicates no selection of the graph creating process, the main menu control unit 101 advances the process to Step S6 whereat it is judged whether the created graph exists (whether the graph data 31 exists). As described above, if the graph data 31 does not exist, the process such as the analyzing process and display control process cannot be executed. Therefore, if it is judged that the created graph does not exist, the main menu control unit 101 advances the process to Step S7 whereat a message prompting graph creation is displayed on the monitor to thereafter return the process to Step S1 and repeat the succeeding processes.

If it is judged at Step S6 that the graph exists, the main menu control unit 101 advances the process to Step S8 to execute a process selected from processes prepared beforehand, such as attribute setting, graph modifying, graph holding control, and termination processes. After completion of the process at Step S8, the main menu control unit 101 terminates the main menu process.

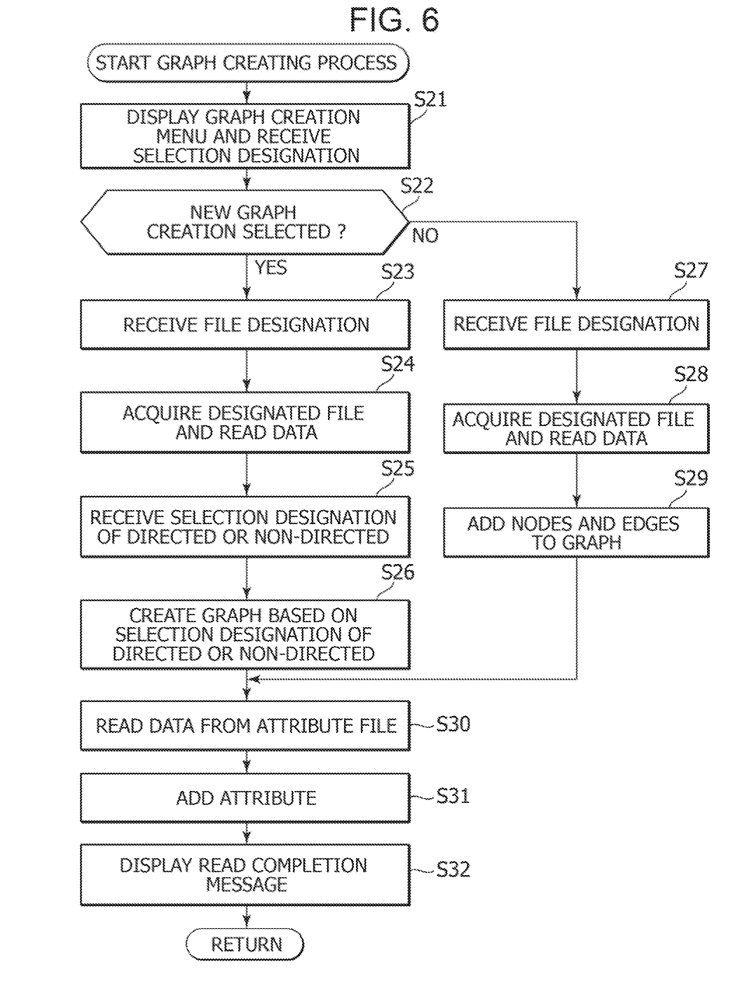

Next, with reference to the flow chart of FIG. 6, description will be made on an example of the sequence of the graph creating process to be executed at Step S4 of FIG. 5.

As the graph creating process starts, at Step S21 the graph creating control process 102 controls the output unit 52 to display a graph creating menu on the monitor, and controls the input unit 51 to receive a menu selection designation in the graph creating menu.

As described earlier, the graph creating process is a process of representing a network in graph format. In this case, a network may be graphed as a new graph, or a created graph may be added to an already existing graph to form one graph. The graph creating menu is a GUI for making a user select one of these two processes. For example, the graph creasing menu has a GUI button (or link, tab or the like) having a legend “create new graph” and a GUI button having a legend “add to already existing graph”. A user operates the input unit 51 to move a cursor and select the process by selecting one of the GUI buttons.

Upon reception of a selection designation of whether a new graph is created and displayed or whether a graph (additional graph) to be added to an already created graph (existing graph) is created to additionally display the graph, the graph creating control unit 102 advances the process to Step S22 whereat it is judged whether the selection designation indicates a selection of creating a new graph.

If it is judged that the new graph creation is selected, the graph creating control unit 102 advances the process to Step S23 to control the input unit 51 and output unit 52 to receive designation of a file name of the network file 41 to be used for graph creation, by displaying a GUI or the like. As the file name is designated, at Step S24 the graph creating control unit 102 controls the read unit 26 to read and acquire the network file 41 designated by the user from the storage unit 13 and read the data.

At Step S25 the graph creating control unit 102 controls the input unit 51 and output unit 52 to receive a directed/non-directed selection designation which is a selection designation of whether a directed graph or a non-directed graph is created, by displaying a GUI or the like. As this preparation is effected, at Step S26 the graph creating control unit 102 controls the data converting unit 22 to generate the graph data 31. As the data converting unit 22 generates the graph data 31, the graph creating control unit 102 makes the holding unit 12 hold the graph data 31, and advances the process to Step S30.

If it is judged at Step S22 that the selection designation indicates that an additional graph to be added to the existing graph is created and the existing graph added with the additional graph is displayed, then the graph creating control unit 102 advances the process to Step S27, controls the input unit 51 and output unit 52, and receives a designation of a file name of the network file 41 to be used for graph creation, by displaying a GUI or the like. As the file name is designated, at Step S28 the graph creating control unit 102 controls the read unit 26 to read and acquire the files (network file 41 and the like) designated by the user from the storage unit 13 and read the data. At Step S29 the graph creating control unit 102 controls the data converting unit 22 to make the data converting unit create the additional graph from the read data and add nodes and edges of the additional graph to the existing graph. As the data converting unit 22 adds the additional graph and updates the graph data 31, the graph creating control unit 102 makes the holding unit 12 hold the graph data 31, to thereafter advance the process to Step S30.

At Step S30 the graph creating control unit 102 reads data from the node attribute file 42 and edge attribute file 43 if these files exist, and adds at Step S31 the read attributes to the network of the graph data 31. If these attribute files do not exist, the graph creating control unit 102 omits these processes and advances the process to Step S32. After completion of adding the attributes, at Step S32 the graph creating control unit 102 controls the output unit 52 to display on the monitor a read completion message notifying a read completion to the user, and to terminate the graph creating process and return the process to Step S4 of FIG. 5 to execute the processes at Step S5 and succeeding Steps.

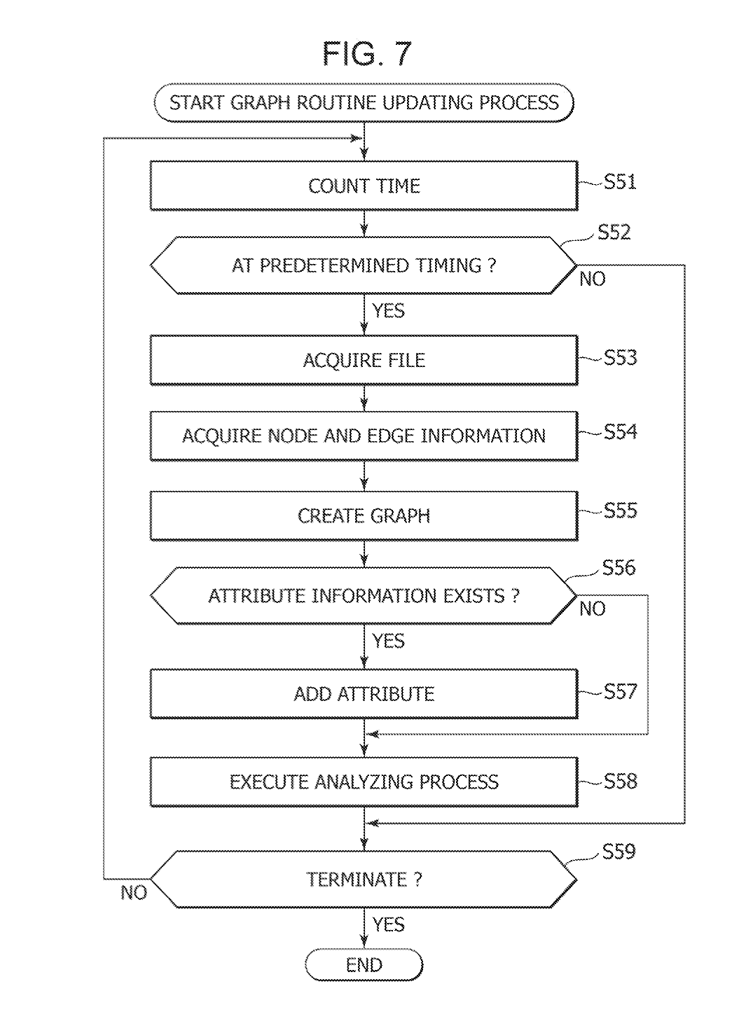

Next, with reference to the flow chart of FIG. 7, description will be made on the sequence of the graph routine updating process to be started at Step S5 of FIG. 5. The graph routine updating process is a process of routinely reflecting the update of the network file 41 upon the graph, without any designation by the user. This process is executed always in the state that there exists at least one graphed network, i.e., while the graph data 31 exists in the holding unit 12.

As the graph routine updating process starts, at Step S51 the routine updating control unit 103 counts time, and judges at Step S52 whether the present time is a predetermined fixed timing. If it is judged that the present time is the fixed timing, the process is advanced to Step S53.

At Step S53 the routine updating control unit 103 acquires the network file 41 corresponding to the graph data 31 from the storage unit 13, and reads at Step S54 the node attribute file 42 and edge attribute file 43 from the storage unit 13 to acquire the node information and edge information. At Step S55 the routine updating control unit 103 controls the data converting unit 22 to create a graph based on the acquired information. At Step S56 the routine updating control unit 103 judges whether attribute information such as node attributes and edge attribute exists. If it is judged that the attribute information exists, the process is advanced to Step S57 whereat the routine updating control unit controls the data converting unit 22 to add the attributes to nodes and edges of the graph to thereafter advance the process to Step S58. If it is judged at Step S56 that the attribute information does not exist, the routine updating control unit 103 omits the process at Step S57 and advances the process to Step S58.

At Step S58 the routine updating control unit 103 controls the analyzing unit 27 to make the analyzing unit execute an analyzing process for the created (updated) graph based on predetermined fixed settings. The analyzing process includes: analysis based on the number of edges at each node; analysis based on an influence degree (betweenness centrality) of each node upon another node; analysis using a clustering coefficient representative of how tightly nodes are interconnected; analysis using the shortest path length which is a distance between nodes along an edge route (path); analysis using a structural hole of a network; analysis based on a pattern of an edge attribute of an edge connected to each node; calculation of a node score representative of a node value based on a connected edge; re-calculation of a node score of own node upon update of a node score of another node; and the like. The analyzing process may be any process or may be omitted. After completion of the analyzing process, the routine updating control unit 103 makes the holding unit 12 hold the graph data 31, and controls the output unit 52 to display the graph (analyzed results) on the monitor, to thereafter advance the process to Step S59. If it is judged at Step S52 that the present time is not the fixed timing, the routine updating control unit 103 advances the process to Step S59.

At Step S59 the routine updating control unit 103 judges whether the graph routine updating process is to be terminated. For example, if it is judged that the graphed network (i.e., graph data 31) exists and the graph routine updating process is not to be terminated, the routine updating control unit 103 returns the process to Step S51 to repeat the succeeding processes. If it is judged at Step S59 that the power is to be turned off or the graph routine updating process is to be terminated because the power source is to be turned on or the graph (i.e., graph data 31) to be routinely updated does not exist, the routine updating control unit 103 terminates the graph routine updating process.

In the above description, although the graph is routinely updated, this updating process may not be routinely updated, but this process may be executed, for example, when a fixed event occurs.

Next, description will be made on various processes to be executed at Step S8 of FIG. 5.

When a process other than graph creation is selected in the main menu in the state that the graph data 31 exists, the selected process is executed. The process of this type is, for example, a process that a user sets (also adds) attributes to nodes and edges of a graph displayed on the monitor. When a user selects this attribute setting process in the main menu, the attribute setting control unit 104 (FIG. 4) executes the attribute setting process.

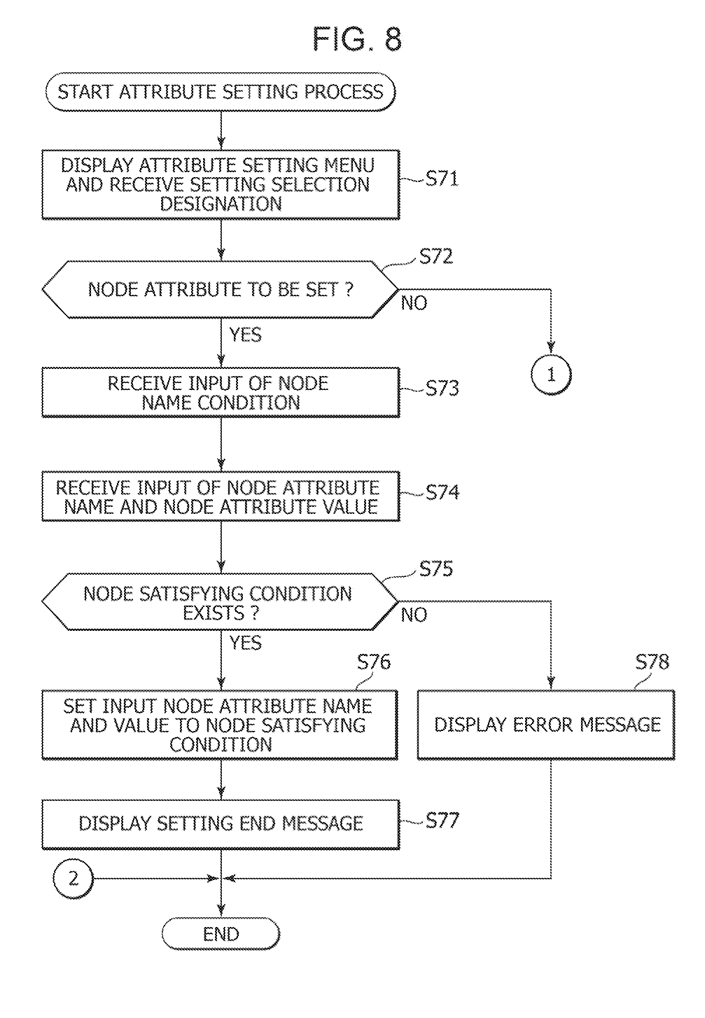

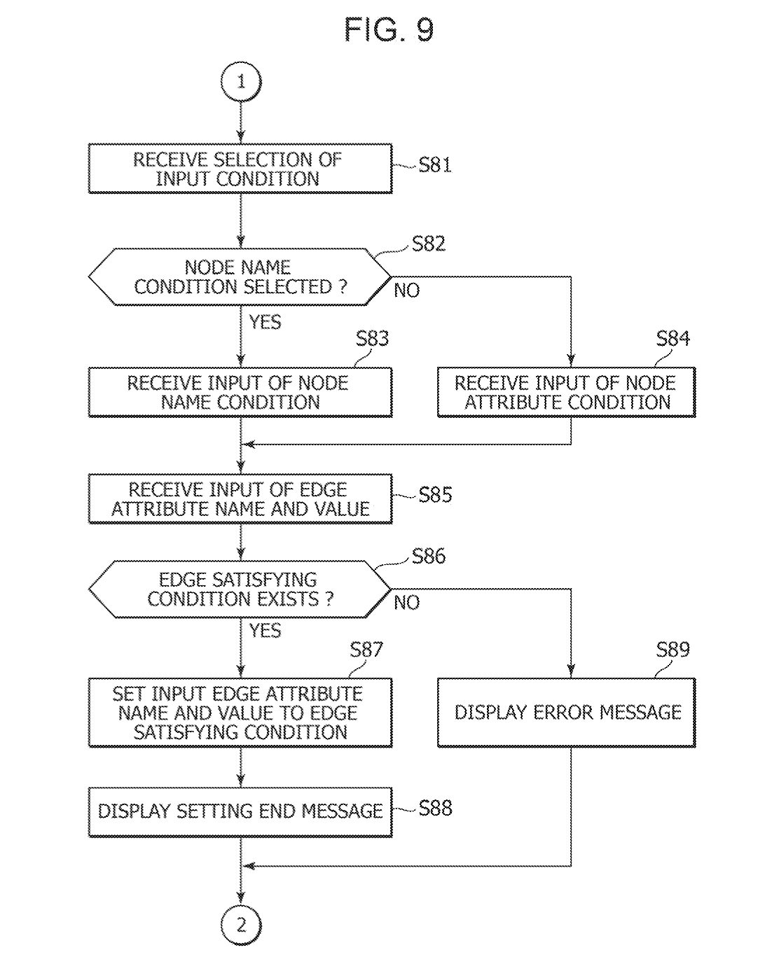

With reference to the flow charts of FIGS. 8 and 9, description will be made on an example of the sequence of the attribute setting process.

As the attribute setting process starts, at Step S71 the attribute setting control unit 104 controls the input unit 51 and output unit 52 to display an attribute setting menu on the monitor and receive a setting selection designation.

The attribute setting menu is a GUI for making a user select setting of either a node attribute or an edge attribute. The user operates the input unit 51 to move a cursor or the like to select setting of either a node attribute or an edge attribute. Based on the setting selection designation input via the input unit 51 in this manner, at Step S72 the attribute setting control unit 104 judges whether the node attribute is to be set.

If it is judged that the node attribute is to be set, the node attribute setting unit 111 of the attribute setting control unit 104 advances the process to Step S73 whereat the node attribute setting unit 111 controls the input unit 51 and output unit 52 to receive a node name condition by displaying on the monitor a GUI for making the user select a node to which an attribute is to be set. This selection method is arbitrary. For example, a list of nodes existing in the graph may be displayed to make a user select one of the nodes, or the user may be made to input a portion or the whole of the node name to select a node whose name is coincident with or contains the input character string. Namely, in this selection, since the user inputs the node name as a condition (filtering condition), a target node can be searched from a plurality of nodes through filtering, even if the identification information can not be grasped completely, or node attributes of a plurality of nodes can be set at a time.

Namely, the user can set easily the node attribute of each node, even in a complicated network having a number of nodes.

As the node name condition is input, at Step S74 the node attribute setting unit 111 controls the input unit 51 and output unit 52 to display a GUI for setting an attribute name and an attribute value on the monitor and receive an input of a node attribute name and a node attribute value. The user selected a node adds a new node attribute to the selected node. To this end, the user inputs the node attribute name and node attribute value to be added, by using GUI displayed on the monitor.

Upon reception of an input of the node attribute name and node attribute value, the node attribute setting unit 111 advances the process to Step S75 whereat it is judged whether there exists the node corresponding to the node name condition input at Step S73. If it is judged that the node exists, the process is advanced to Step S76 whereat the data converting unit 22 is controlled to make the data converting unit set the node attribute name and node attribute value input at Step S74 to the node satisfying the condition. After completion of the setting, the node attribute setting unit 111 makes the holding unit 12 hold the graph data 31 added with the node attributes, to thereafter advance the process to Step S77 whereat the output unit 52 is controlled to display a setting end message on the monitor to thereafter terminate the attribute setting process.

If it is judged at Step S75 that the node satisfying the input node name condition does not exist in the graph, the node attribute setting unit 111 advances the process to Step S78 whereat the output unit 52 is controlled to display an error message notifying the user of a failure of attribute settings to thereafter terminate the attribute setting process.

If it is judged at Step S72 that the user selects setting of the edge attribute and does not set the node attribute, the attribute setting control unit 104 advances the process to Step S81 of FIG. 9.

At Step S81 of FIG. 9 the edge attribute setting unit 112 controls the input unit 51 and output unit 52 to receive an input condition selection by the user, by displaying a GUI on the monitor.

Since the edge has no name (although there is a node name, there is no edge name), the user identifies an edge whose attribute is to be set, by using information on the nodes connected to the edge. Namely, the user sets attributes to an edge connected to the node corresponding to the filtering condition. The network analysis assisting apparatus 1 has two types of node information, a node name and a node attribute name, and the edge attribute setting unit 112 makes the user select one of the conditions of the node name and node attribute name.

At Step S82 the edge attribute setting unit 112 judges whether the user selects the node name condition. If it is judged that the node name condition is selected, the process is advanced to Step S83 whereat the input unit 51 and output unit 52 are controlled to receive an input of the node name condition by displaying a GUI on the monitor, to thereafter advance the process to Step S85.

If it is judged at Step S82 that the node name condition is not selected and the node attribute condition is selected, the edge attribute setting unit 112 advances the process to Step S84 whereat the input unit 51 and output unit 52 are controlled to receive an input of the node attribute condition by displaying a GUI on the monitor, to thereafter advance the process to Step S85.

In effect, similar to the case of the node described above, also in the case of the edge, a plurality of edges can be selected at a time. A target edge can be searched in accordance with the filtering condition. Namely, a user can set the edge attribute of each edge even in a complicated network having a number of edges.

Upon reception of the node condition, at Step S85 the edge attribute setting unit 112 controls the input unit 51 and output unit 52 to receive an input of the edge attribute name and edge attribute value to be set to the identified edge to be processed, by displaying a GUI on the monitor.

At Step S86 the edge attribute setting unit 112 judges whether there exists an edge (an edge connected to the node corresponding to the input node condition) corresponding to the condition input in the manner described above. If the corresponding edge exists, the edge attribute setting unit 112 advances the process to Step S87 whereat the data converting unit 22 is controlled to set the input edge attribute name and edge attribute value to the edge corresponding to the condition, and makes the holding unit 12 hold the graph data 31 added with the edge attributes. At Step S88, a setting end message notifying the user of setting end is displayed to thereafter terminate the attribute setting process.

If it is judged at Step S86 that there exists no edge corresponding to the condition, the edge attribute setting unit 112 advances the process to Step 89 whereat the output unit 52 is controlled to display an error message notifying the user of a failure of attribute setting, to thereafter terminate the attribute setting process.

As described above, the network analysis assisting apparatus 1 can set to the graph not only the node attribute but also the edge attribute, i.e., information representative of the meaning of interconnection between elements in the network. Namely, the network analysis assisting apparatus 1 can express not only which node exist in the network and which node is related to which node, but also which node and which node are related in what manner.

For example, if the node is a user and the edge is an interconnection between users, although a related art network can express which users are coupled together or which users are coupled by the what number of times, the related art network cannot express, for example, the type of contents of interconnection. As described above, the network analysis assisting apparatus 1 can set such information as edge attributes. Therefore, the network analysis assisting apparatus 1 can assist more suitable analyses to allow a user to easily analyze the complicated network in various manners.

In the above description, nodes are filtered by a node name condition, and edges are filtered by a node name condition or node attribute name condition. The types of conditions are not limited thereto, but nodes and edges may be filtered by other conditions. For example, node or edge attribute values, the direction of an edge (in the case of a directed graph) and the like may be used as the conditions. A plurality of conditions may be combined.

Since the network is displayed as a graph and attributes are set to nodes and edges as described above when necessary, a user can visually grasp the network and can analyze the network easily. However, a more complicated network is required to be analyzed in recent years. The more complicate the target network for analysis is, it becomes more difficult to analyze the network and the importance of assistance increases more. However, with simple representation of a graph, a user cannot analyze sufficiently. Namely, in order to analyze a more complicated network, operations of more various types are required such as changing nodes and edges in a displayed graph.

The graph modifying control unit 105 executes a graph modifying process for updating nodes and edges in a displayed graph, by controlling the graph modifying unit 23. The graph modifying process is designated by using the main menu. As a user selects the graph modifying process on the main menu, the graph modifying process is executed at Step S8 shown in FIG. 5.

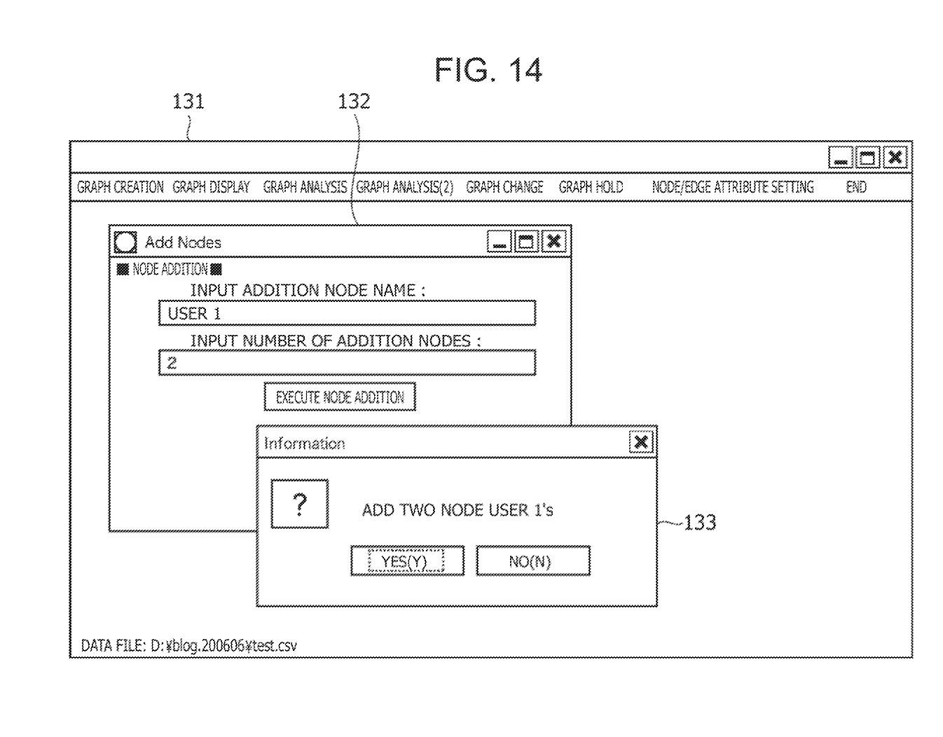

The sequence of the graph modifying process will be described with reference to the flow charts shown in FIGS. 10 to 13, and when necessary, the description will be made by referring to FIGS. 14 to 29.

As the graph modifying process starts, at Step S101 the graph modifying control unit 105 controls the input unit 51 and output unit 52 to display a graph modifying menu, which is a GUI for making a user select a process regarding graph modifying, on the monitor and to receive a process selection designation from the graph modifying menu.

Upon reception of the graph selection designation, at Step S102 the graph modifying control unit 105 judges from the process selection designation whether a node is to be added to the displayed graph. If it is judged that a node is to be added, the process advances to Step S103. At Step S103 the node adding unit 121 judges from the process selection designation whether an already existing node is copied or a new node is generated. If it is judged that the already existing node is copied, the process advances to Step S104.

At Step S104 the node adding unit 121 displays a GUI on the monitor to receive a node name input. Namely, if the already existing node is copied, the node adding unit 121 designates the already existing node as a copy source by using the node name.

FIG. 14 is a diagram showing a display example of a GUI to be used for node copy. As shown in FIG. 14, at Step S104 the node adding unit 121 displays on the monitor a main window 131 for displaying a main menu as well as a node addition window 132 for making a user input a node name. The node addition window 132 has a field for inputting a node name and a field for designating the number of addition nodes. The user inputs data in these fields and depresses a “node addition execute” button so that a confirmation window 133 is displayed. As the user depresses an “Yes (Y) button” in the confirmation window 133, the node name input (and the number of addition nodes) are received. In the example shown in FIG. 14, it is designated that two nodes “user 1” are added (copied).

Reverting to FIG. 10, at Step S105 the node adding unit 121 judges whether the node corresponding to the received node name exists. If it is judged that the node exists, the process advances to Step S106. At Step S106 the graph modifying unit 23 is controlled to copy the node having the designated node name, and at Step S107 an edge owned by the copy source node is added to the new node to update the graph (graph data 31). After completion of this update, the node adding unit 121 terminates the graph modifying process.

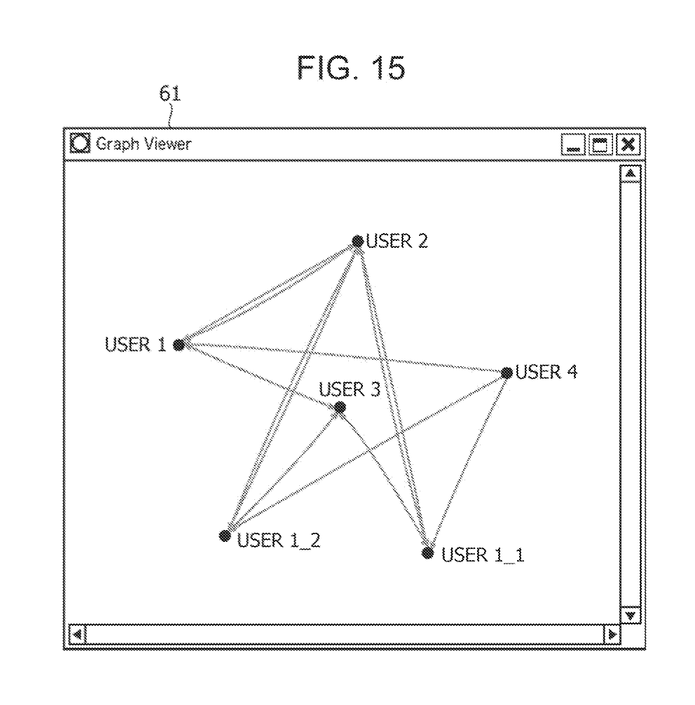

FIG. 15 is a diagram showing a display example of a graph in which two nodes are added to the graph shown in FIG. 2 based on the designation input to the node addition window 132. The graph shown in FIG. 15 is added with “user 1_{—}1” and “user 1_{—}2” which are copies of the node “user 1”. Since these nodes are copies of the “user 1”, the node attribute is common to that of the “user 1”. The two nodes “user 1_{—}1” and “user 1_{—}2” are connected, via edges having the same edge attributes as those of the “user 1”, to the “user 2”, “user 3” and “user 4”. In other words, the nodes “user 2”, “user 3” and “user 4” are connected to the users “user 1”, “user 1_{—}1” and “user 1_{—}2”, respectively by the edges having the same edge attributes (and same directions).

Since a user can designate a copy source node by using its node name, the user can easily designate a target node and can add its copy to the graph. Since the node name functions as identification information of each node, the node adding unit 121 changes the node name when the node is copied at Step S106. In this case, in order to make a user easily grasp that the node is copied and which node is a copy source, the node adding unit 121 creates a node name of a copy destination node by utilizing the node name of the copy source node. In the example shown in FIG. 15, the node adding unit 121 creates the node names “user 1_{—}1” and “user 1_{—}2” of the copy destination nodes by adding a new identification number to the node name “user 1” of the copy source.

Reverting to FIG. 10, if it is judged at Step S105 that the corresponding node does not exist, the node adding unit 121 advances the process to Step S108 whereat an error process such as displaying an error message notifying the user of impossible copy is displayed on the monitor to thereafter terminate the graph modifying process.

If it is judged at Step S103 that a node is newly generated based on the process selection designation, the node adding unit 121 advances the process to Step S109 whereat a GUI is displayed on the monitor to receive a node attribute name input.

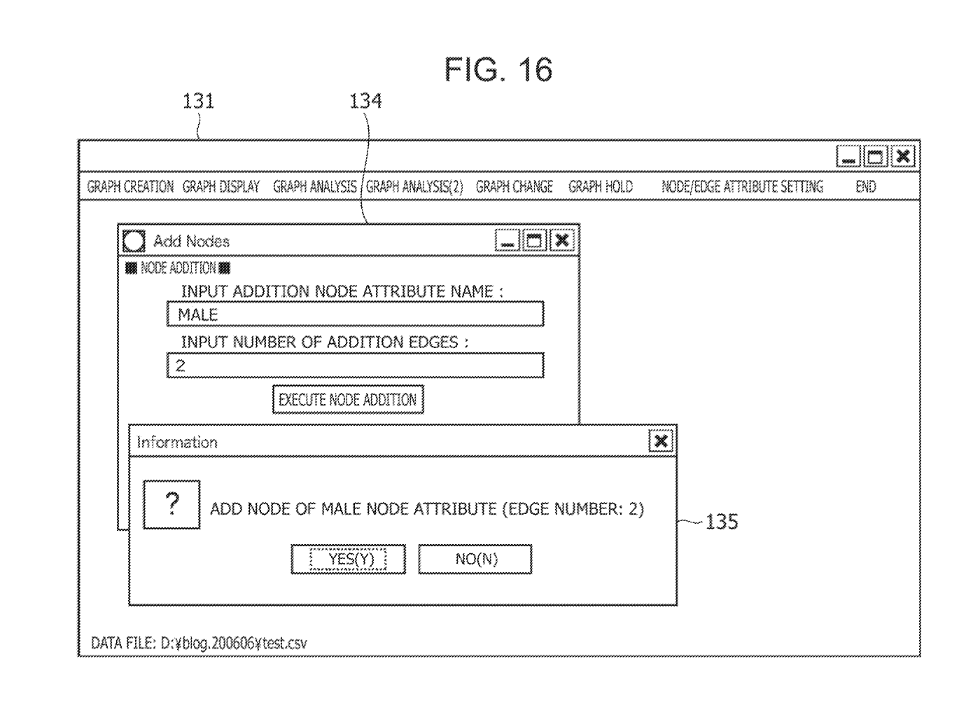

FIG. 16 is a diagram showing a display example of a GUI which is displayed when a node is newly generated. As shown in FIG. 16, at Step S109 the node adding unit 121 displays on the monitor the main window 131 for displaying a main menu as well as a node addition window 134 for making a user input a node attribute name. The node addition window 134 has a field for inputting a node attribute name and a field for designating the number of edges to be added to the node. The user inputs data in these fields and depresses a “node addition execute” button so that a confirmation window 135 is displayed. As the user depresses an “Yes (Y) button” in the confirmation window 135, the node attribute name input (and the number of addition edges) are received. In the example shown in FIG. 16, it is designated that the node attribute is “male” and a node having two edges is added.

Although the node name is node identification information, the node name does not have information representative of a meaning of a network constituent element. For network analysis, it is therefore more important that which type of a node is added, than the node name of the node to be added. Therefore, when a node is newly generated, the node adding unit 121 makes a user designate the node attribute name. In this manner, a user can analyze the influence of the added node upon the whole network in accordance with the property (meaning) of the added node. The node name of the added node may be generated arbitrarily by the graph modifying unit 23 or may be designated by a user.

Reverting to FIG. 10, at Step S 10 the node adding unit 121 judges whether the node attribute corresponding to the received node attribute name exists. If it is judged that the corresponding node attribute does not exist, the process advances to Step S108 whereat an error process is executed to thereafter terminate the graph modifying process. Namely, the node attribute of the node to be newly added uses an already existing node attribute.

Obviously, a new node attribute may be assigned. However, for example, if the node attribute is not simply a name but the node attribute is assigned with a node weight (node score) or another parameter, or the node attribute has relevance to another node attribute, it is preferable to set not only the node attribute name but also such additional information. If the node addition window 134 is structured in such a manner that the node attribute is selected from already existing node attributes, the judgment process at Step S110 can be omitted.

If it is judged at Step S110 that the corresponding node attribute does not exist, the node adding unit 121 advances the process to Step S111. At Step S111 the graph modifying unit 23 is controlled to newly generate the node having the designated node attribute, and at Step S112 an edge number designation input to the node addition window 134 shown in FIG. 16 is received. At Step S113 the graph modifying unit 23 is controlled to add edges corresponding in number to the designated edge number so as to connect the newly added node and another node randomly selected from already existing nodes. As the edges are added, the node adding unit 121 terminates the graph modifying process.

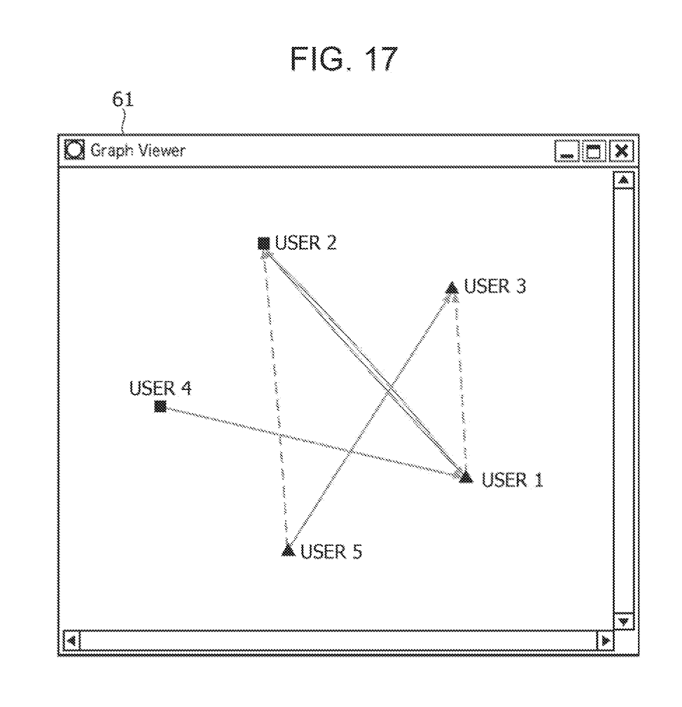

FIG. 17 is a diagram showing a display example of a graph in which a node “user 5” is newly added to the graph shown in FIG. 2 based on the designation input to the node addition window 134 shown in FIG. 16. In the graph shown in FIG. 17, the newly added node is connected to randomly selected two nodes “user 2” and “user 3” by edges. The edge attributes of these edges may be designated by a user.

In addition to node random selection, nodes to be added with edges may be selected in accordance with an arbitrary rule such as preferential selection described, for example, in “Mean-field theory for scale-free random networks. Physica A”, A. L. Barabasi, R. Albert, H. Jeong, 272, 173-187 (1999).

In adding a node to a network, what is a node attribute (meaning of an element) is important. If a node addition location is not important, the node adding unit 121 can reduce a load on a user by automatically determining edge connection destinations randomly (or by a predetermined method).

Reverting to FIG. 10, if it is judged at Step S102 that a node is not added based on the process selection designation, the graph modifying control unit 105 advances the process to Step S121 in FIG. 11 whereat it is judged whether an edge is added. If it is judged that a user designates an edge addition in the graph modifying menu, the graph modifying control unit 105 advances the process to Step S122 based on the process selection designation.

At Step S122 the edge adding unit 123 judges from the process selection designation whether a node to be connected to an addition edge is designated. If it is judged that a node is not designated, the process advances to Step S123 whereat a GUI is displayed on the monitor to receive an edge attribute input.

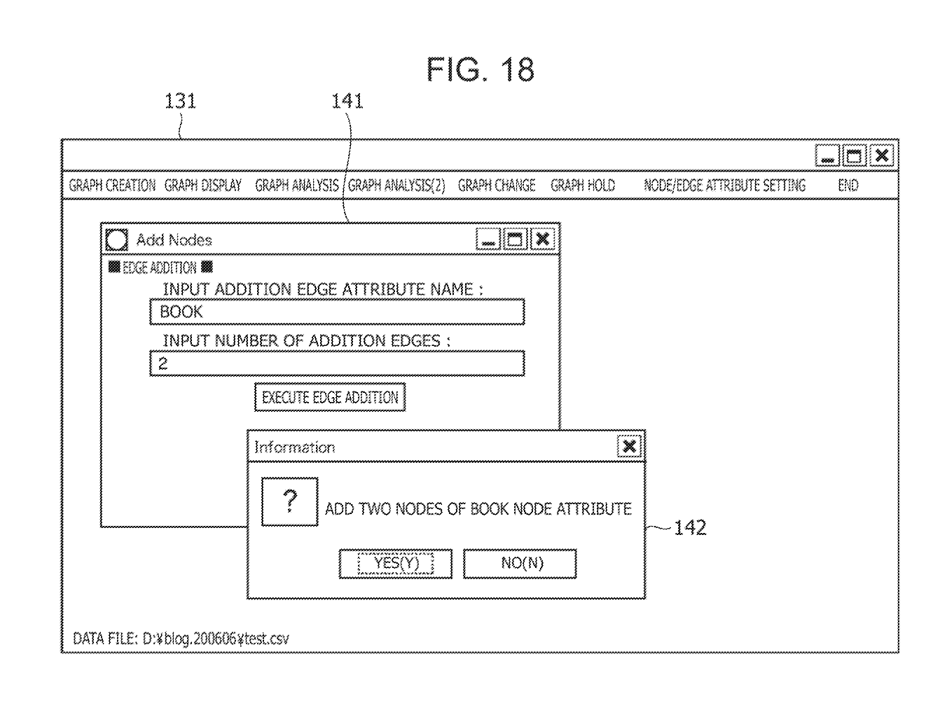

FIG. 18 is a diagram showing a display example of a GUI which is displayed when an edge is added by designating only an edge attribute. As shown in FIG. 18, at Step S123 the edge adding unit 123 displays on the monitor the main window 131 for displaying a main menu as well as an edge addition window 141 for making a user input an edge attribute name. The edge addition window 141 has a field for inputting an edge attribute name and a field for designating the number of edges to be added to the node. The user inputs data in these fields and depresses an “edge addition execute” button so that a confirmation window 142 is displayed. As the user depresses an “Yes (Y) button” in the confirmation window 142, the edge attribute name input (and the number of addition edges) are received. In the example shown in FIG. 18, it is designated that two edges of the edge attribute “book” are added.

Similar to the node, in analyzing a network, “what type of an edge is added” becomes important. Therefore, the edge adding unit 123 makes a user designate an edge attribute name of an addition edge. Edge addition is addition of a relation between nodes, and its meaning is different from node addition. More specifically, for example, in a network for analyzing speech services, a user is used as a node, personal information of the user is used as a node attribute, usage of the speech services is used as an edge, and a usage time zone is used as an edge attribute. In the network of this type, by studying the influence of addition of a new node, it becomes possible to perform mainly an analysis regarding the number of users, such as the influence upon the whole network by usage of the services by a user of which type (i.e., a user of which type should be invited). In contrast, by adding a new edge, it becomes possible to perform mainly an analysis regarding a service providing method, such as “the usage number is to be increased in which time zone” and “the usage number is to be increased between which users”. Although it is obvious that both the cases can perform an analysis other than that described above, the main purpose and skillful field of analysis is different between node addition and edge addition.

Reverting to FIG. 11, at Step S124 the edge adding unit 123 judges whether the edge corresponding to the received edge attribute name exists. If it is judged that the corresponding edge exists, the process advances to Step S125 whereat two nodes are selected randomly, and the graph modifying unit 23 is controlled to add an edge having the designated edge name between the selected nodes. After completion of the edge addition, the edge adding unit 123 terminates the graph modifying process.

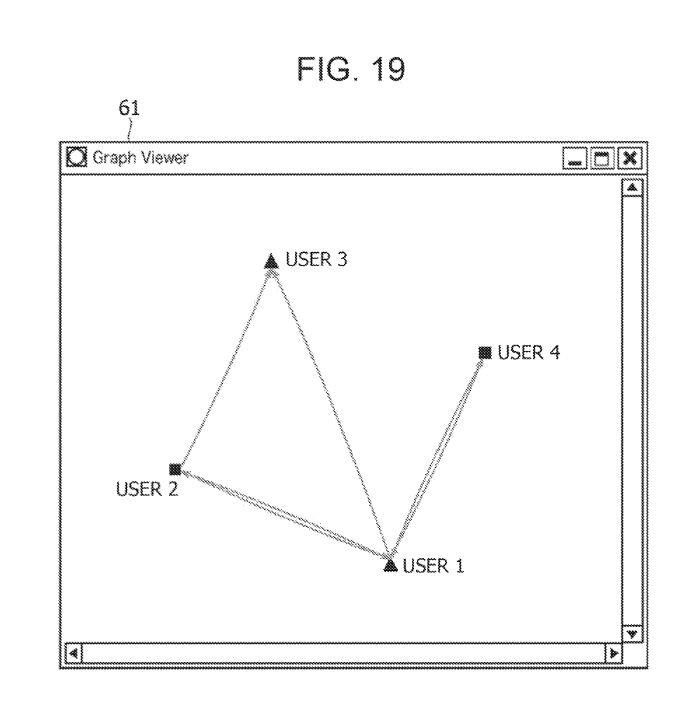

FIG. 19 is a diagram showing a display example of a graph in which two edges having the edge attribute “book” are newly added to the graph shown in FIG. 2 based on the designation input to the edge adding window 141 shown in FIG. 18. The graph shown in FIG. 19 is added with the above-described edge between the randomly selected two nodes “user 2” and “user 3” and between the randomly selected two nodes “user 1” and “user 4”.

In addition to random selection, nodes to be added with an edge may be selected in accordance with an arbitrary rule such as preferential selection described above.

In adding an edge to a network, what is an edge attribute (a meaning of interconnection between elements) is important. If an addition location of an edge is not important, the edge adding unit 123 can reduce a load on a user by automatically determining the addition location randomly (or by a predetermined method), as described earlier.

Reverting to FIG. 11, if it is judged at Step S124 that the corresponding edge does not exist, the edge adding unit 123 advances the process to Step S126 whereat an error process such as displaying an error message on the monitor is executed to thereafter terminate the graph modifying process.

If it is judged at Step S122 that the nodes to be added with an edge is designated based on the process selection designation, the edge adding unit 123 advances the process to Step S127 whereat a GUI is displayed on the monitor to receive an input of an edge attribute and a node name.

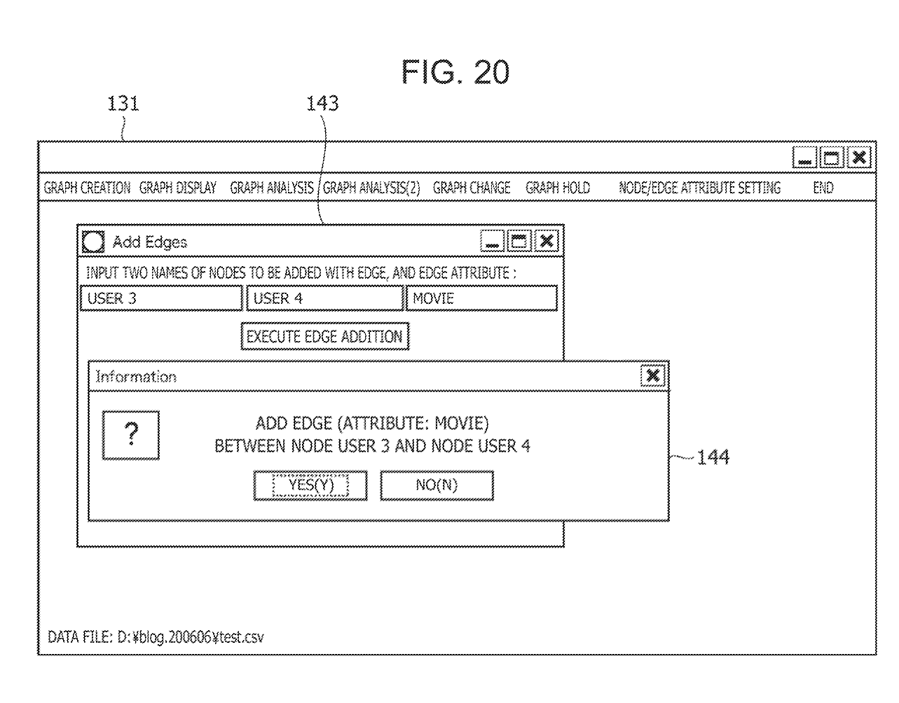

FIG. 20 is a diagram showing a display example of a GUI to be displayed when a node name is designated. As shown in FIG. 20, at Step S127 the edge adding unit 123 displays on the monitor the main window 131 for displaying a main menu as well as an edge addition window 143 for making a user input an edge attribute name and a node name. The edge addition window 143 has a field for inputting a node name to be added with an edge and a field for designating the edge attribute of the edge. The user inputs data in these fields and depresses an “edge addition execute” button so that a confirmation window 144 is displayed. As the user depresses an “Yes (Y) button” in the confirmation window 144, an input of the edge attribute and node name is received. In the example shown in FIG. 20, it is designated that an edge having an edge attribute “movie” is added between the nodes “user 3” and “user 4”.

Namely, in this case, a user can add an edge having a desired edge attribute to a desired location. A user can therefore perform a detailed designation to the extent that “an edge of which type is added to which location”. Therefore, a user can perform a more sophisticated analysis such as “a difference of influence upon the whole network to be caused by an addition location of an edge”.

Reverting to FIG. 11, at Step S128 the edge adding unit 123 judges whether the edge corresponding to the received edge attribute name exists already. If it is judged that the corresponding edge does not exist, the process returns to Step S126 whereat an error process is executed to thereafter terminate the graph modifying process. Namely, the edge attribute of an addition edge uses an already existing edge attribute. If the edge attribute is selectively designated from already existing edge attributes in the edge addition window 143, the judgment process at Step S128 can be omitted. If it is judged at Step S128 that the corresponding edge exists, the edge adding unit 123 advances the process to Step S129 whereat the graph modifying unit 23 is controlled to add the edge having the designated edge attribute between the designated two nodes. After completion of the edge addition, the edge adding unit 123 terminates the graph modifying process.

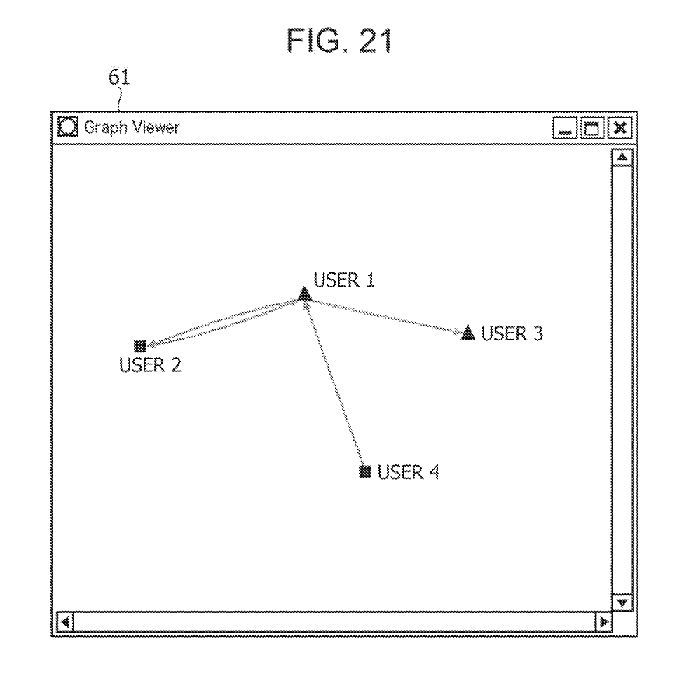

FIG. 21 is a diagram showing a display example of a graph in which an edge is newly added between the designated nodes. In the example shown in FIG. 21, an edge having an edge attribute “movie” is newly added between the two nodes “user 3” and “user 4” in the graph shown in FIG. 2 based on the designation input to the edge adding window 143 shown in FIG. 20.

Reverting to FIG. 11, if it is judged at Step S121 that an edge is not added based on the process selection designation, the graph modifying control unit 105 advances the process to Step S131 shown in FIG. 12 whereat it is judged whether a node is deleted. If it is judged that a user designates to delete a node in the graph modifying menu, the graph modifying control unit 105 advances the process to Step S132 based on the process selection designation.

At Step S132 the node deleting unit 122 judges from the process selection designation whether the node to be deleted is designated by a node name. If it is judged that the node is designated by a node name, the process advances to Step S133 whereat a GUI is displayed on the monitor to receive a node name input.

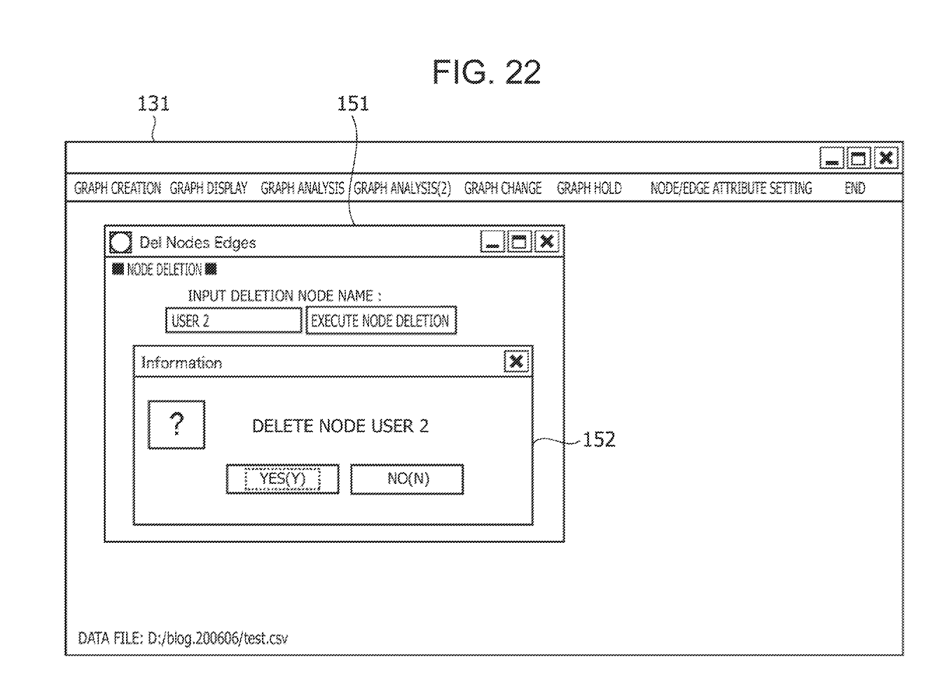

FIG. 22 is a diagram showing a display example of a GUI to be displayed when a node is deleted by designating a node name. As shown in FIG. 22, at Step S133 the node deleting unit 122 displays on the monitor the main window 131 for displaying a main menu as well as a node deletion window 151 for making a user input a node name. The node deletion window 151 has a field for inputting a node name. The user inputs a node name in this field and depresses a “node deletion execute” button so that a confirmation window 152 is displayed. As the user depresses an “Yes (Y) button” in the confirmation window 152, an input of the node name or a node to be deleted is received. In the example shown in FIG. 22, it is designated that a node having the node name “user 2” is deleted.

By designating the node name, a user can designate specifically the node to be deleted.

Reverting to FIG. 12, at Step S134 the node deleting unit 122 judges whether the node corresponding to the received node name exists. If it is judged that the corresponding edge exists, the process advances to Step S135 whereat the graph modifying unit 23 is controlled to delete the node. After completion of the deletion, the node deleting unit 122 terminates the graph modifying process.

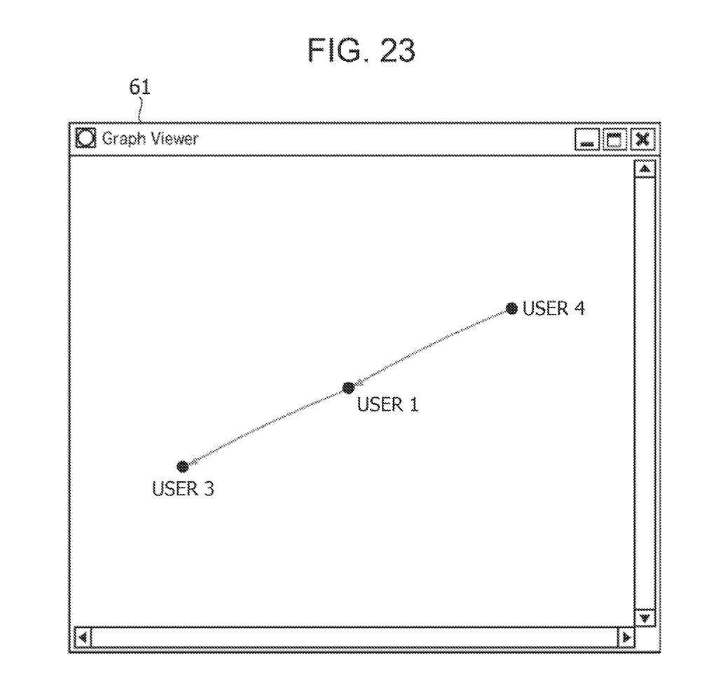

FIG. 23 is a diagram showing a display example of a graph in which the node designated by the node name is deleted based on the designation input to the node deletion window 151 shown in FIG. 22. In the example shown in FIG. 23, the node of “user 2” is deleted. In this case, an unnecessary edge connected to the node of “user 2” is also deleted.

Reverting to FIG. 12, if it is judged at Step S134 that the corresponding node does not exist, the node deleting unit 122 advances the process to Step S136 whereat an error process such as displaying an error message on the monitor is executed to thereafter terminate the graph modifying process.

If it is judged at Step S132 that the node to be deleted is designated not by the node name but by the node attribute name, based on the process selection designation, the node deleting unit 122 advances the process to Step S137 whereat a GUI is displayed on the monitor to receive a node attribute name input.

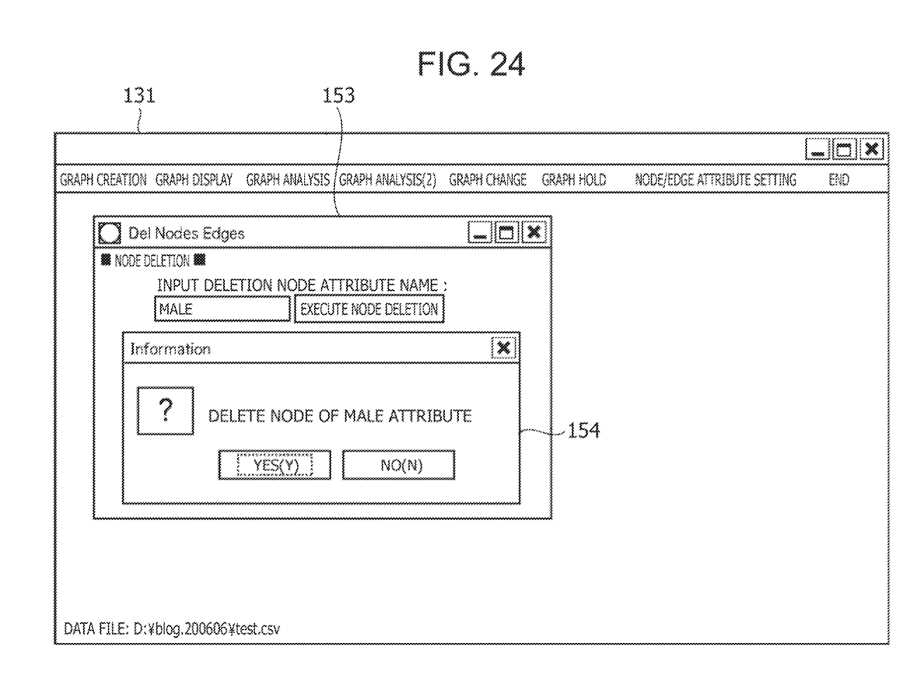

FIG. 24 is a diagram showing a display example of a GUI to be displayed when a node to be deleted is designated by a node attribute name. As shown in FIG. 24, at Step S137 the node deleting unit 122 displays on the monitor the main window 131 for displaying a main menu as well as a node deletion window 153 for making a user input a node attribute name. The node deletion window 153 has a field for inputting a node attribute name of the node to be deleted. The user inputs a node attribute name in this field and depresses a “node deletion execute” button so that a confirmation window 154 is displayed. As the user depresses an “Yes (Y) button” in the confirmation window 154, an input of the node attribute name is received. In the example shown in FIG. 24, it is designated that a node having the node attribute “male” is deleted.

Reverting to FIG. 12, at Step S138 the node deleting unit 122 judges whether the node corresponding to the received node attribute name exists. If it is judged that the corresponding node does not exist, the process returns to Step S136 whereat an error process is executed to thereafter terminate the graph modifying process.

This judgment process at Step S138 can be omitted, for example, if the node attribute is selectively designated from already existing node attributes in the node deletion window 153. If it is judged at Step 138 that the corresponding node exists, the node deleting unit 122 advances the process to Step S139 whereat the graph modifying unit 23 is controlled to randomly select one node from the corresponding nodes and delete the selected node. After completion of the node deletion, the node deleting unit 122 terminates the graph modifying process.

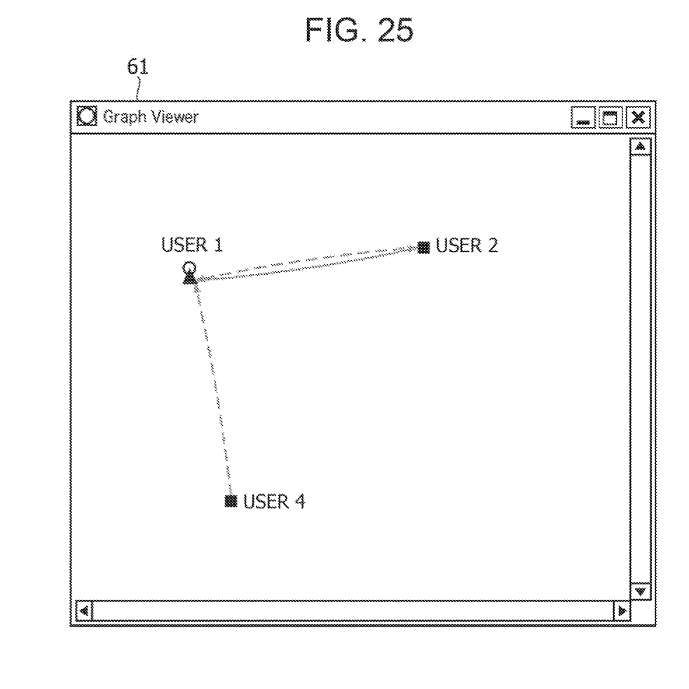

FIG. 25 is a diagram showing a display example of a graph in which the node is deleted by designating the node attribute. In the example shown in FIG. 25, the node of “user 3” having the node attribute “male” is deleted from the graph shown in FIG. 2 based on the designation input to the node deletion window 153 shown in FIG. 24.

In the above description, if there are a plurality of nodes corresponding to the node name at Step S139, the node to be deleted is randomly selected. In addition, the node may be selected in accordance with an arbitrary rule such as apex inactivation described in “Highly clustered scale-free networks”, K. Kiemm, V. M. Eguiluz, Physical Review E, 65, 036123 (2002).

In the network analysis, “which type of a node is deleted” from the whole network may become important. For example, in analyzing a network in which the shape of an edge (interconnection between nodes) is not important, the influence upon the network is similar even if which one of nodes is deleted if the nodes have the same attribute. In this case, the nodes are selected by using the node attribute as described above, and the node actually deleted is automatically selected so that the node deleting unit 122 can reduce a load on a user.

Reverting to FIG. 12, if it is judged at Step S131 that not the node but the edge is deleted based on the process selection designation, the graph modifying control unit 105 advances the process to Step S141 in FIG. 13.

At Step S141 the edge deleting unit 124 judges from the process selection designation whether the edge to be deleted is designated by the node names connected to the edge. If it is judged that the edge is designated by the node names, the process advances to Step S142 whereat a GUI is displayed on the monitor to receive a node name input.

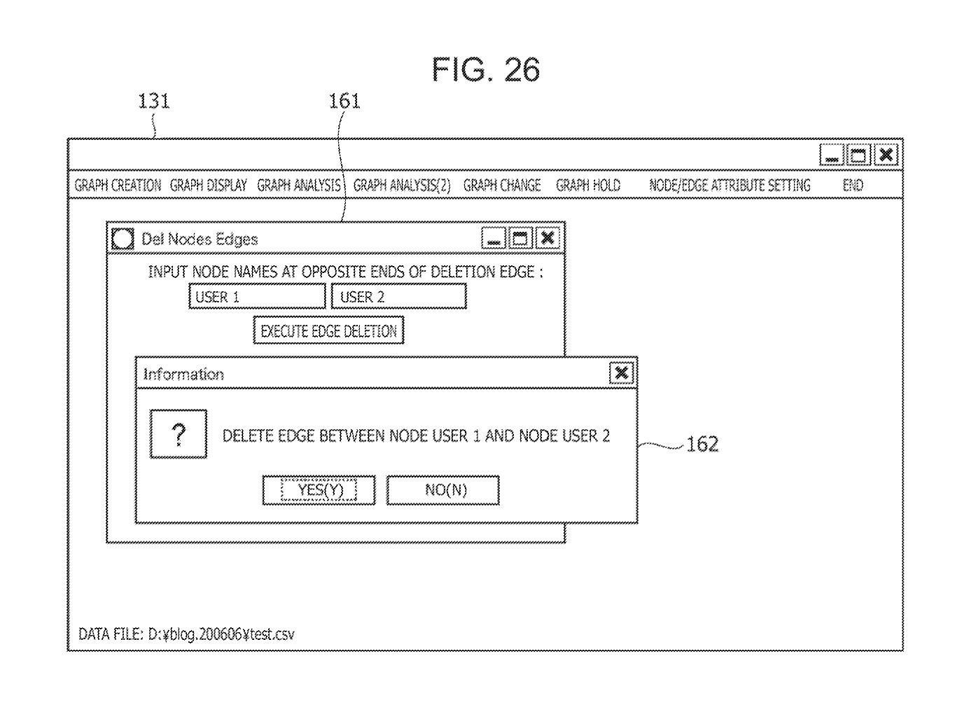

FIG. 26 is a diagram showing a display example of a GUI to be displayed when an edge is deleted by designating a node name. As shown in FIG. 26, at Step S142 the edge deleting unit 124 displays on the monitor the main window 131 for displaying a main menu as well as an edge deletion window 161 for making a user input a node name. The edge deletion window 161 has two fields for inputting a node name of the node to be deleted. The user inputs in these fields the node names at opposite ends of the edge to be designated, and depresses an “edge deletion execute” button so that a confirmation window 162 is displayed. As the user depresses an “Yes (Y) button” in the confirmation window 162, an input of the node names for the edge to be deleted is received. In the example shown in FIG. 26, it is designated that the edge is deleted between the node of “user 1” and the node of user 2”.

Namely, in this case, a user can delete a desired edge by specifically identifying it. For example, the user can analyze the influence and the like upon the network when the relation (edge) between particular nodes is deleted. In this case, the user pays attention more to the locations than the meaning of the relation, and can analyze by giving prominence more to “the relation between which users is disconnected” than to “which relation is disconnected”.

Reverting to FIG. 13, at Step S143 the edge deleting unit 124 judges whether the edge corresponding to the received node names exists. If it is judged that the corresponding edge exists, the process advances to Step S144 whereat the graph modifying unit 23 is controlled to delete the edge. After completion of the edge deletion, the edge deleting unit 124 terminates the graph modifying process.

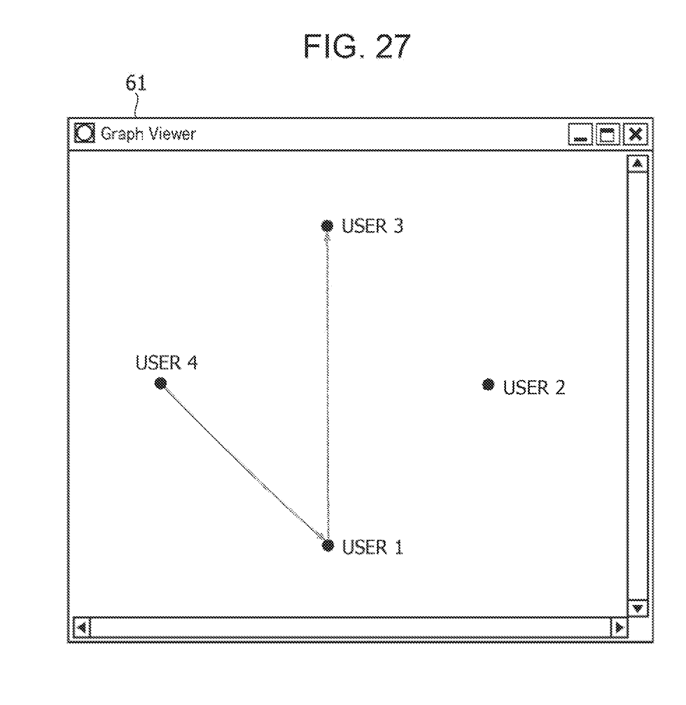

FIG. 27 is a diagram showing a display example of a graph in which an edge is deleted based on the designation input to the edge deletion window 161 shown in FIG. 26. In the example shown in FIG. 27, the edge interconnecting “user 1” and “user 2” is deleted.

Reverting to FIG. 13, if it is judged at Step S143 that the corresponding node does not exist, the edge deleting unit 124 advances the process to Step S145 whereat an error process such as displaying an error message on the monitor is executed to thereafter terminate the graph modifying process.

If it is judged at Step S141 from the process selection designation that the edge to be deleted is designated not by a node name but by an edge attribute name, the edge deleting unit 124 advances the process to Step S146 whereat a GUI is displayed on the monitor to receive an edge attribute name input.

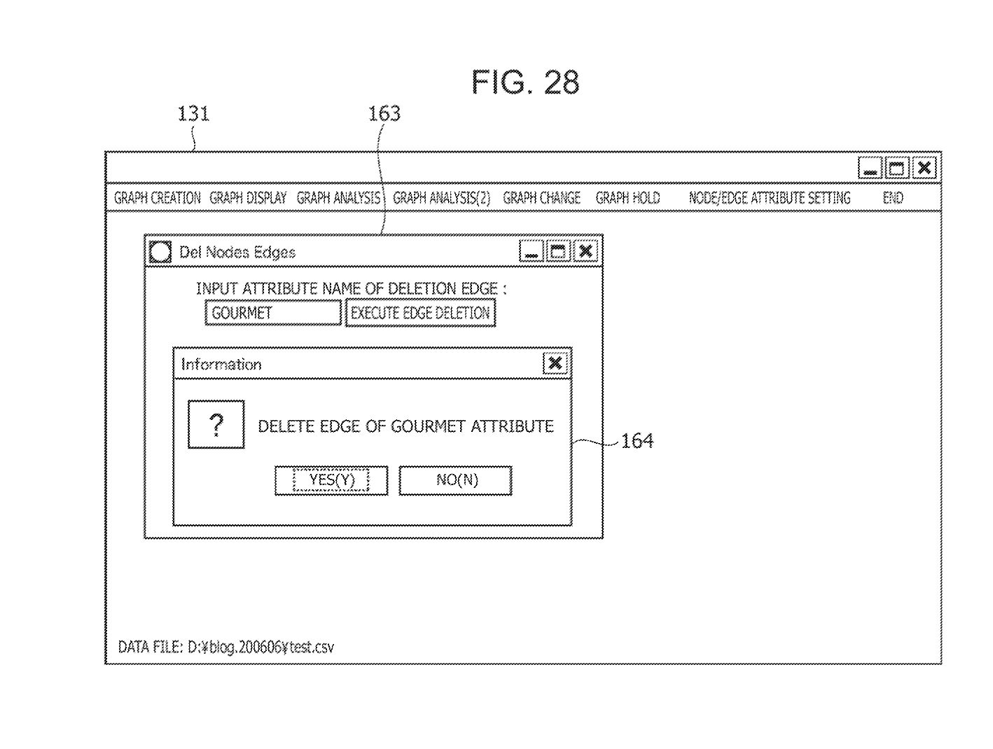

FIG. 28 is a diagram showing a display example of a GUI to be displayed when an edge to be deleted is designated by an edge attribute name. As shown in FIG. 28, at Step S146 the edge deleting unit 124 displays on the monitor the main window 131 for displaying a main menu as well as an edge deletion window 163 for making a user input an edge attribute name. The edge deletion window 163 has a field for inputting an edge attribute name of an edge to be deleted. The user inputs an edge attribute name in this field and depresses an “edge deletion execute” button so that a confirmation window 164 is displayed. As the user depresses an “Yes (Y) button” in the confirmation window 164, an input of the edge attribute name is received. In the example shown in FIG. 28, it is designated that the edge having an edge attribute “gourmet” is deleted.

Reverting to FIG. 13, at Step S147 the edge deleting unit 124 judges whether the edge corresponding to the received edge attribute name exists. If it is judged that the corresponding edge does not exist, the process returns to Step S145 whereat an error process is executed to thereafter terminate the graph modifying process. The judgment process at Step S147 can be omitted, for example, if the edge attribute is selected from already existing edge attributes in the edge deletion window 163. If it is judged at Step S147 that the corresponding edge exists, the edge deleting unit 124 advances the process to Step S148. At Step S148 one edge is selected randomly from corresponding edges, and the graph modifying unit 23 is controlled to delete the edge. After completion of the edge deletion, the edge deleting unit 124 terminates the graph modifying process.

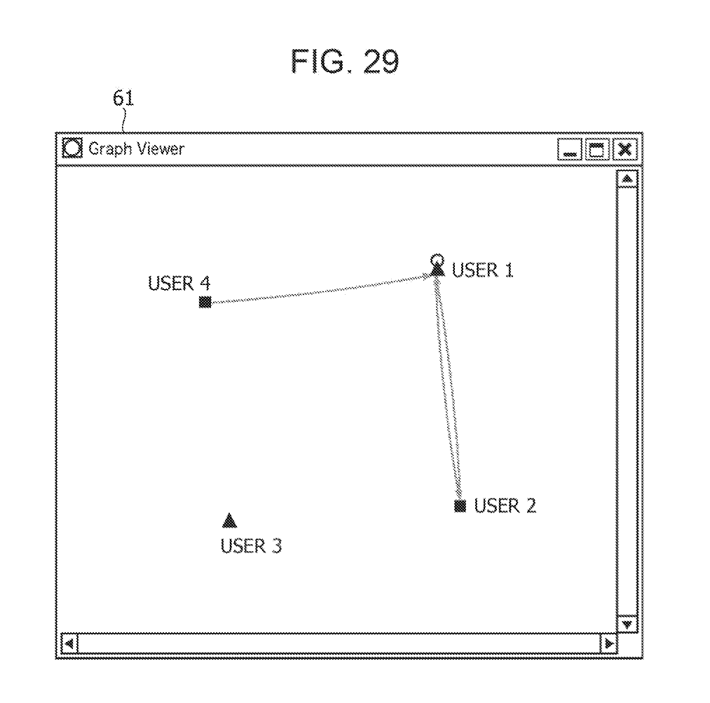

FIG. 29 is a diagram showing a display example of a graph in which the edge designated by the edge attribute is deleted. In the example shown in FIG. 29, the edge (edge between “user 1” and “user 2”) having the edge attribute “gourmet” is deleted from the graph shown in FIG. 2 based on the designation input to the edge deletion window 163 shown in FIG. 28.

By designating an edge to be deleted by using the edge attribute, the edge deleting unit 124 can make a user perform a sophisticated analysis such as “what influence appears by deleting which relation from a network”. Namely, the edge deleting unit 124 can assist a more sophisticated analysis which is impossible if a user is made simply designate an edge to delete the designated edge.

In the above description, if there are a plurality of edges corresponding to the edge attribute at Step S148, the edge deleting unit 124 randomly selects the edge to be deleted. In addition, the edge may be selected in accordance with an arbitrary rule such as apex inactivation described in “highly clustered scale-free networks”, K.

Klemm, V M. Eguiluz, Physical Review E, 65, 036123 (2002).

Addition and deletion of nodes and edges have been described above. The network analysis assisting apparatus 1 may combine these processes, the attribute setting process and the like to allow the apparatus to perform transfer of nodes and edges, change in attributes and the like.

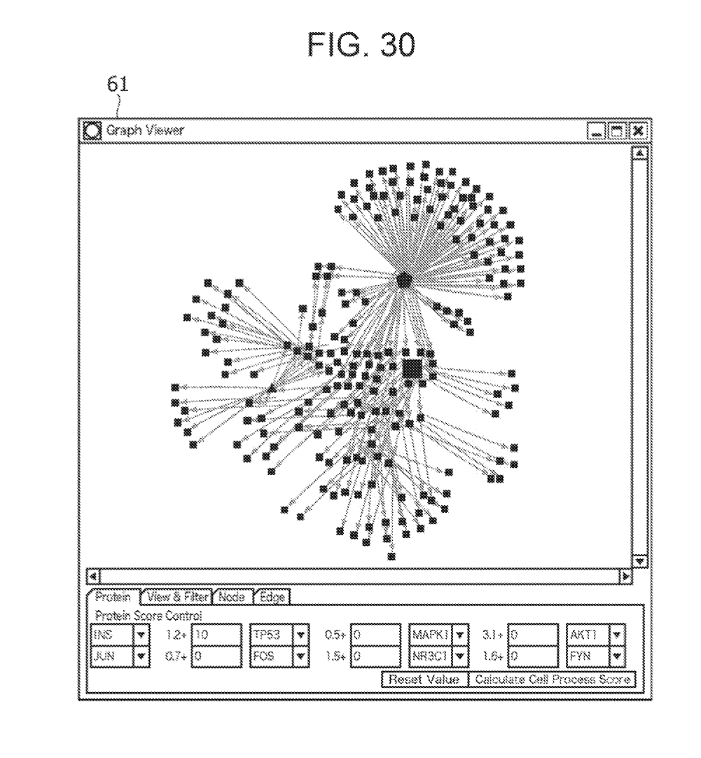

By executing various processes such as the graph modifying process described above, it is possible to update nodes and edges to dynamically change the network. For example, as shown in FIG. 30, it is possible to display only necessary information by deleting some nodes and edges and to add virtual nodes and edges. Therefore, by utilizing the network analysis assisting apparatus 1, a user can grasp reliably the tendency and characteristics of a network and can perform various more sophisticated analyses. Simulation and the like of a network can be made by combining the graph modifying process by the graph modifying unit 23 and tie analyzing process by the analyzing unit 27.

Further, as shown in FIG. 30, the display size of each node may be designated in an operation area 63 of a graph viewer 61, an important node upon which edges are concentrated may be displayed in a large size to emphasize it, or a color and a shape may also be changed.

As a user selects a holding process in the main menu, the latest graph data 31 updated in the above manner can be stored in a file. As the graph holding designation is received, the graph holding control unit 106 starts a holding process, converts the graph data 31 into a file to be stored in the storage unit 13.

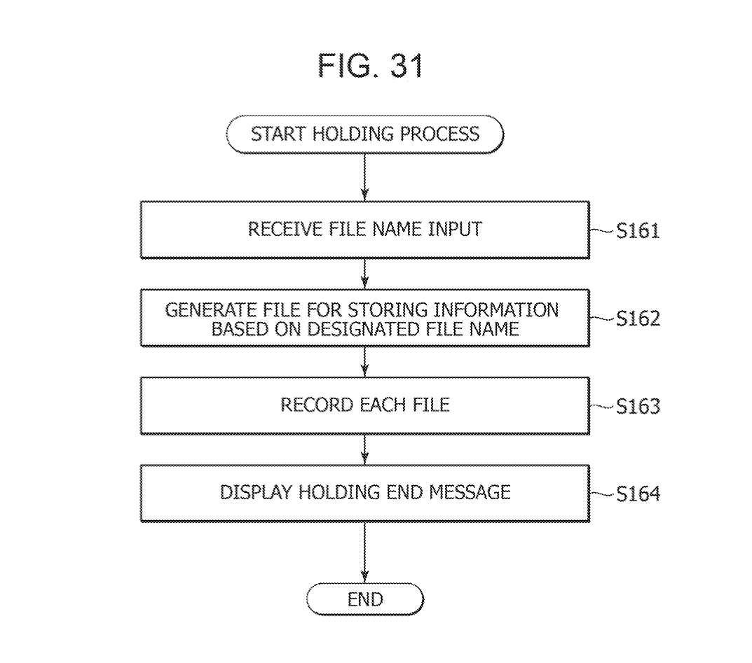

With reference to the flow chart of FIG. 31, description will be made on an example of the sequence of the holding process.

As the holding process starts, at Step S161 the graph holding control unit 106 controls the input unit 51 and output unit 52 to receive a file name input from a user, by displaying on the monitor a GUI for making a user enter a file name and receiving an input to GUI.

At the file name input is received, at Step S162 the graph holding control unit 106 controls the data converting unit 22 to convert the graph data 31 into a file for storing each information (network file 41, node attribute file 42, edge attribute file 43, analyzed data file 44 and the like), based on the designated file name.

At Step S163 the graph holding control unit 106 controls the write unit 25 to record each generated file in the storage unit 13. After completion of recording the file, at Step S164 the graph holding control unit 106 controls the output unit 52 to display a holding completion message notifying a user of holding completion to thereafter terminate the holding process.

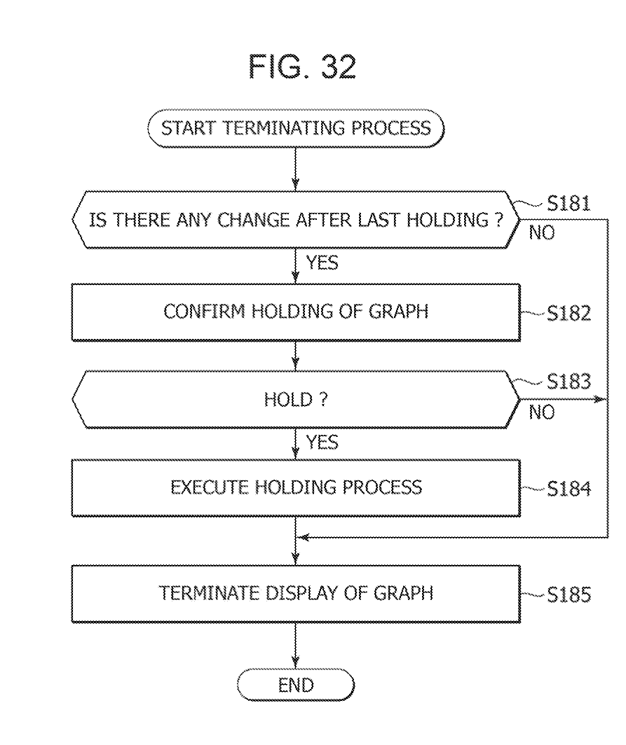

When the user selects the termination process in the main menu, the termination process control unit 107 executes the termination process to terminate graph display. With reference to the flow chart of FIG. 32, description will be made on an example of the sequence of the termination process.

As the termination process starts, at Step S181 the termination process control unit 107 judges whether the graph data 31 was changed because of the analyzing process, attribute setting process or the like executed after the last (latest) holding. If it is judged that the graph data was changed, the process is advanced to Step S182 whereat the input unit 51 and output unit 52 are controlled to confirm graph holding by displaying a GUI for making a user to enter whether the graph is to be held and receiving an input to GUI. Upon reception of a user designation, the termination process control unit 107 advances the process to Step S183 whereat it is judged from the user designation whether the graph is to be held or not. If it is judged that the graph is to be held, the process is advanced to Step S184 whereat the termination process control unit 107 controls the graph holding control unit 106 to execute the holding process. After completion of the holding process, at Step S185 the termination process control unit 107 terminates graph display to thereafter terminate the termination process.

If it is judged at Step S181 that the graph was not changed after the last holding, or if the user designates not to hold the graph at Step S183, the termination process control unit 107 advances the process to Step S185 whereat the output unit 52 is controlled to terminate graph display to thereafter terminate the termination process.

As described above, the network analysis assisting apparatus 1 allows a user to define the attribute of not only the node but also the edge to thereby facilitate a network analysis and provide a variety of analyses by using the attributes.

In the above description, although only one network analysis assisting apparatus 1 is used, a network system may be realized by using a plurality of apparatus having the structure shown in FIG. 1 and interconnected via a network.

For example, although the network file 41 and the like are stored in the storage unit 13 in FIG. 1, these files nay be acquired from a server or the like via a network.

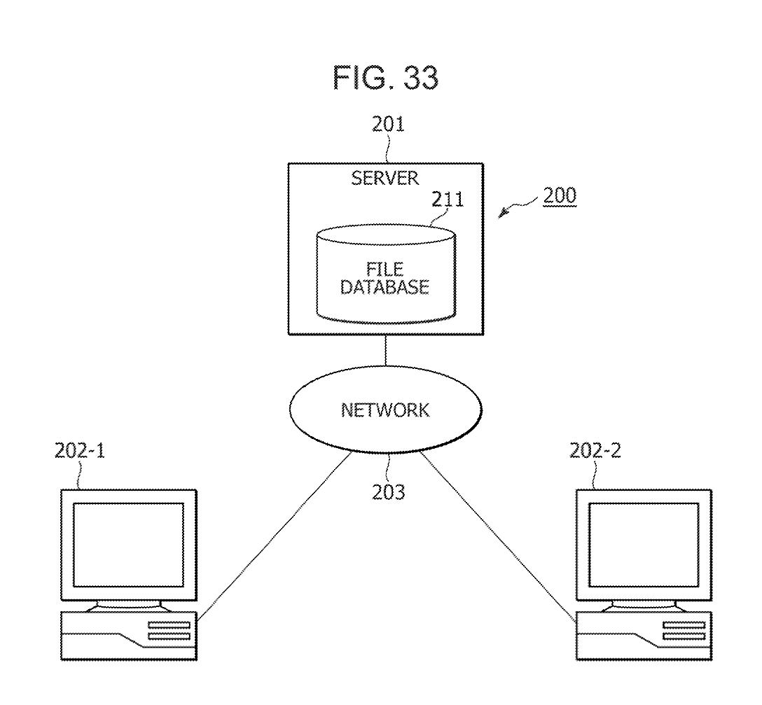

FIG. 33 is a diagram showing another embodiment of the present invention. In FIG. 33, a network analysis assisting apparatus system 200 is a network system constituted of a server 201, a client 202-1 and a client 202-2 interconnected via a wired or wireless network 203 typically a LAN and the Internet. The network analysis assisting apparatus system is a system for assisting an analysis of a network formed from nodes and edges, to be performed by users of the clients 202-1 and 202-2. In the following, if the clients 202-1 and 202-2 are not necessary to be distinguished, the clients are simply called a client 202.

The server 201 has a file database 211 for registering the network file 41 to analyzed data file 44. A file generated by the client 202 is registered in the file database 211 and managed collectively.

Although the client 202 has basically the same structure as that of the network analysis assisting apparatus 1 shown in FIG. 1, the network file 41 to analyzed data file 44 are not stored in the storage unit 13, but supplied to the server 201 and registered in the file database 211. Therefore, also in reading a file, the client 202 accesses the server 201 via the network 203 and acquires a necessary file from the file database 211.

With this arrangement, the files can be shared by each client 202.

In the network analysis assisting apparatus system 200 shown in FIG. 33, the number of servers 201, client 202 and networks 203 are arbitrary, and other structures may be included.

It is sufficient if the server 201 and client 202 can realize the processes to be executed by the network analysis assisting apparatus shown in FIG. 1, and it is arbitrary that which process is executed at which component. For example, the client 202 may execute only the user interface process such as image display and input reception, and the server 201 may execute each process such as a data converting process and an analyzing process.

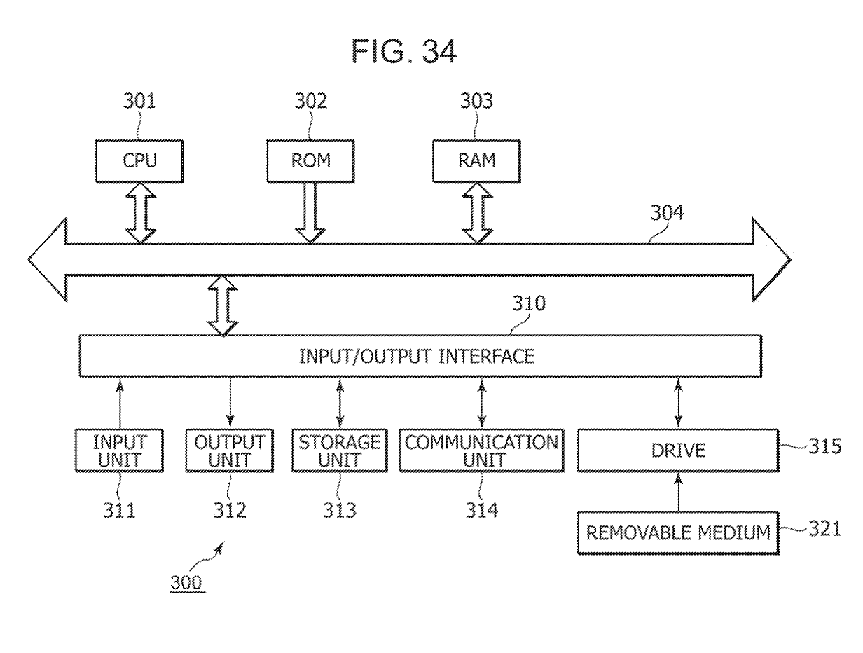

Although the above-described series of processes may be realized by hardware, they may be realized by software. In this case, a personal computer such as shown in FIG. 34 may be used.

In FIG. 34, a central processing unit (CPU) 301 of a personal computer 300 executes various processes in accordance with a program stored in a read only memory (ROM) 302 or a program loaded from the storage unit 313 to a RAM 303.

RAM 303 stores data and the like necessary for CPU 301 to execute various processes, when necessary.

CPU 301, ROM 302 and RAM 303 are interconnected via a bus 304. The bus 304 is also connected to an input/output interface 310.

The input/output interface 310 is connected to an input unit 311 such as a keyboard and a mouse, an output unit 312 such as a cathode ray tube (CRT) and a liquid crystal display (LCD), the storage unit 313 made of a hard disk or the like, and a communication unit 314 made of a modem or the like. The communication unit 314 executes a communication process via a network including the Internet.

The input/output interface 310 is also connected to a drive 315 when necessary. A removable medium 321 such as a magnetic disk, an optical disk, a magnetic optical disk and a semiconductor memory is loaded in the drive. A computer program read from the removal medium is installed in the storage unit 313 when necessary.

When the above-described series of processes is executed by software, a program constituting the software is installed from the network and recording medium.

The recording medium includes, for example, as shown in FIG. 34, the removal medium 321 distributed to user for supplying a program separately from the apparatus main body, such as a magnetic disk (including a flexible disk), an optical disk (including a compact disk—read only memory (CD-ROM), and a digital versatile disk (DVD)), a magnetic optical disk (including a mini-disk (MD) (registered trademark)), a semiconductor memory, respectively recording a program, ROM 302, a hard disk included in the memory unit 313, or the like.

In this specification, steps describing the program provided by a recording medium contain not only a process to be executed time sequentially in the order of written statements but also a process to be executed parallel or independently without being processed time sequentially.

In this specification, a system is the whole apparatus constituted of a plurality of devices (apparatus).

The structure described as one apparatus in the foregoing may be divided and structured as a plurality of apparatus. Conversely, the structure described as a plurality of apparatus in the foregoing may be integrated as one apparatus. The structure other than that described above may be added to the structure of each apparatus. If the structure and operation as the whole system are substantially the same, a portion of the structure of an apparatus may be included in the structure of another apparatus. Namely, the embodiments of the present invention are not limited to the embodiments described above, but various modifications are possible within the scope not departing from the main features of the present invention.

The present invention is applicable to an information processing apparatus.

The present document contains subject matter related to Japanese Patent Application No. 2006-228598 filed in the Japan Patent Office on Aug. 25, 2006, the entire content of which being incorporated herein by reference.

What is claimed is:

1. A network analysis assisting apparatus for assisting analysis of a network formed from a plurality of nodes and edges indicating interconnection between the nodes, the apparatus comprising:
modifying control means for receiving a designation of a node attribute indicating a meaning of a node to be added to the network or a designation of an edge attribute indicating a meaning of an edge to be added to the network, and determining an addition location of the node or edge to be added in the network, based on the node attribute or the edge attribute designated by the designation, and a structure of the network.

2. The network analysis assisting apparatus according to claim 1, wherein:
the modifying control means further receives a designation of a number of nodes or edges to be added, and determines addition locations of nodes or edges in the network, a same number of the addition locations as the number of nodes or edges designated by the designation being determined.

3. The network analysis assisting apparatus according to claim 1, further comprising:
modifying means for adding the nodes or edges to the addition locations of the network determined by the modifying control means.

4. The network analysis assisting apparatus according to claim 1, wherein:
the modifying control means further receives a designation of a node attribute indicating a meaning of a node to be deleted from the network or a designation of an edge attribute indicating a meaning of an edge to be deleted from the network, and selects a node or edge to be deleted, based on the node attribute or the edge attribute designated by the designation and the structure of the network.

5. The network analysis assisting apparatus according to claim 4, further comprising:
modifying means for deleting the node or the edge selected by the modifying control means.

6. A network analysis assisting method for a network analysis assisting apparatus that assists analysis of a network formed from a plurality of nodes and edges indicating interconnection between the nodes, the method comprising:
receiving a designation of a node attribute indicating a meaning of a node to be added to the network or a designation of an edge attribute indicating a meaning of an edge to be added to the network, and determining an addition location of the node or edge to be added in the network, based on the node attribute or the edge attribute designated by the designation and a structure of the network.

7. A program executable by a computer for controlling a process of assisting analysis of a network formed from a plurality of nodes and edges indicating interconnection between the nodes,
the program making the computer execute a modifying control step of receiving a designation of a node attribute indicating a meaning of a node to be added to the network or a designation of an edge attribute indicating a meaning of an edge to be added to the network, and determining an addition location of the node or edge to be added in the network, based on the node attribute or the edge attribute designated by the designation and a structure of the network.

8. A recording medium recording the program recited in claim 7.

9. A network analysis assisting apparatus for assisting analysis of a network formed from a plurality of nodes and edges indicating interconnection between the nodes, the apparatus comprising:
a modifying control unit that receives a designation of a node attribute indicating a meaning of a node to be added to the network or a designation of an edge attribute indicating a meaning of an edge to be added to the network, and determining an addition location of the node or edge to be added in the network, based on the node attribute or the edge attribute designated by the designation, and a structure of the network.
